(19) United States
(12) Patent Application Publication
(10) Pub. No.: US 2025/0080863 A1
(43) Pub. Date: Mar. 6, 2025

(54) METHOD OF COLOR CORRECTION

(71) Applicant: NVIDIA Corporation, Santa Clara, CA (US)

(72) Inventors: Chengwu Cui, Gig Harbor, WA (US); Sean Midthun Pieper, Waldport, OR (US); Du-Yong Ng, San Jose, CA (US); Douglas John Taylor, Santa Clara, CA (US)

(21) Appl. No.: 18/242,395

(22) Filed: Sep. 5, 2023

(51) Int. Cl. H04N 23/84; G06T 7/00; G06T 7/90; G06T 11/00; G06V 20/52

(52) U.S. Cl. CPC H04N 23/84; G06T 7/0002; G06T 7/90; G06T 11/001; G06V 20/52; G06T 2207/30168; G06T 2207/30252

(57) ABSTRACT

Apparatuses, systems, and techniques for performing color correction are presented. In at least one embodiment, a color mapping model may be identified that maps colors, within a subspace of an input color space localized around a target color, to an adjusted color space and applied to an input image to adjust a value of one or more pixels of the input image that fall within the subspace. In at least one embodiment, a color mapping model may be initialized that maps colors, within a subspace of an input color space localized around a target color, to an adjusted color space. At least one parameter of the color mapping model may be adjusted to reduce an amount of visible artifacts produced by the color mapping model.

### TECHNICAL FIELD

Embodiments of the disclosure generally relate to image processing, and more specifically, to improved techniques for performing color correction.

### BACKGROUND

Color correction is a process that can be performed to adjust, or “correct,” the colors of a digital image. Color correction, for example, may be used to achieve a more accurate and/or visually pleasing representation of a scene captured in the image. For instance, color correction may be used to adjust the colors of an image to account for unique properties of the digital camera used to capture the image, so that the adjusted image may more accurately represent the colors of a captured scene when reproduced. In other cases, color correction may be used to adjust the aesthetic qualities of an image to suit user preferences. Color correction, for example, can be used to adjust the skin tone of individuals captured in an image or enhance certain colors in a landscape image (e.g., so that the leaves on trees are a vibrant green).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment, according to at least one embodiment;

FIG. 2 illustrates a flow diagram of an example method for performing a color correction process using one or more color mapping models, according to at least one embodiment;

FIG. 3 illustrates a flow diagram of an example method for optimizing one or more color mapping models, according to at least one embodiment;

FIG. 4A illustrates an example of an autonomous vehicle, according to at least one embodiment;

FIG. 4B illustrates an example of camera locations and fields of view for the autonomous vehicle of FIG. 4A, according to at least one embodiment;

FIG. 4C is a block diagram illustrating an example system architecture for the autonomous vehicle of FIG. 4A, according to at least one embodiment;

FIG. 4D is a diagram illustrating a system for communication between cloud-based server(s) and the autonomous vehicle of FIG. 4A, according to at least one embodiment;

FIG. 5 is a block diagram illustrating a computer system, according to at least one embodiment;

FIG. 6 is a block diagram illustrating a computer system, according to at least one embodiment;

FIG. 7 illustrates at least portions of a graphics processor, according to at least one embodiment;

FIG. 8 illustrates at least portions of a graphics processor, according to at least one embodiment.

### DETAILED DESCRIPTION

Color correction is a process that can be performed to adjust, or “correct,” the colors of a digital image. Color correction, for example, may be used to achieve a more accurate and/or visually pleasing representation of a scene captured in the image. Color correction, for instance, may be used to adjust the colors of an image to account for unique properties of the digital camera used to capture the image (e.g., the quantum efficiency of an image sensor, influence of camera optics, etc.), so that the adjusted image may more accurately represent the colors of a captured scene when reproduced (e.g., when printed or rendered on a digital display). In other cases, color correction may be used to adjust the aesthetic qualities of an image to suit user preferences. Color correction, for example, can be used to adjust the skin tone of individuals captured in an image or enhance certain colors in a landscape image (e.g., so that the leaves on trees are a vibrant green). As another example, certain objects, such as a stop sign, are strongly associated by individuals (e.g., in terms of psychological perception) with a particular “memory color.” When such objects are captured in an image, however, they may not present with this color (e.g., the color of a stop sign may appear distorted due to glare or overexposure). Color correction may be used to adjust the colors of the image so that these objects have the expected memory colors.

Color correction may also be used to adjust the colors of an image to produce better results in downstream processing of the image, for example, by computer vision, perception, and/or machine learning or artificial intelligence systems (or other image processing systems). As an illustrative example, use of vision systems in certain applications, such as automotive or aeronautical applications (e.g., to support self-driving vehicles or self-flying drones or aircraft), may have serious safety implications. In such applications, it may be critical for the vision system to be able to accurately detect and/or identify certain objects, such as traffic lights or other traffic signals (e.g., cross-walk signals, etc.). But bright light sources, such as these, may appear distorted when captured using cameras or sensors of the vision systems, such that the objects may not be consistently detected and/or identified when subsequently processed by the vision systems. The distortion may be particularly acute in cameras or sensors having a high dynamic range, which are commonly used in automotive and aeronautical vision systems. Color correction may be used to adjust the color of images so that these objects may more closely match what is expected by the vision system (e.g., by neural networks thereof) so that they may be more readily detected and identified by the vision system.

Automated methods of color correction traditionally involve the use of a color correction matrix (CCM) or a look-up table (LUT). In CCM based approaches, a matrix is used to define a linear relationship between the pixel values of an input image and the pixel values in an adjusted output image, where each pixel in the input and output image may include values for one or more color components (or color channels). By way of example, a 3×3 CCM may be applied to each pixel of an input image (e.g., where each pixel has a red R, G, and B value) to obtain an output pixel (e.g., having adjusted pixel values R′, G′, and B′) and produce a color adjusted output image. The use of CCMs, however, is practically limited to linear transformations that are typically applied across the entire color space of an image. CCMs, therefore, are generally unable to address color issues that arise within a particular region of a color space (e.g., color issues associated with bright light sources, such as traffic lights).

In LUT based approaches, a look-up table is defined that maps each possible pixel value (or ranges of pixel values) of an input image (e.g., of an input color space) to a particular output pixel value (e.g., in an output color space). By way of example, values of each pixel of an input image (e.g., R, G, and B values for each pixel) may be used to index into a 3D LUT to obtain corresponding output pixels (e.g., having adjusted pixel values R′, G′, and B′) and produce a color adjusted output image. While LUTs may be able to affect more complex transformations of an input color space (e.g., as compared to CCMs), they too have practical limitations. For example, in order to adequately capture a desired transformation (e.g., to provide sufficient granularity), LUTs can become relatively large in size (e.g., 3D LUTs are frequently 17×17×17, 33×33×33, or 65×65×65 in size). Creating such LUTs can be a laborious, time-consuming exercise. Generating a LUT, for instance, may involve sampling the entire color space (e.g., by capturing images of samples having a known color or range of colors, which collectively cover the entire color space) and manually adjusting each individual sample as desired (e.g., to obtain a mapping of the specific color(s) in a particular sample to the output color space). Furthermore, the larger the LUT the more difficult it is to adapt, fine tune, inspect, validate, or otherwise manage. LUT-based color correction processes can also be expensive to implement from a hardware perspective, for example, as LUTs may occupy a relatively large footprint in memory.

Embodiments of the present disclosure employ a novel approach to color correction—which may augment or be used alongside traditional CCM or LUT-based approaches—that provides for the adjustment (or warping) of specific colors within a color space. In some embodiments, for example, color mapping models may be defined for localized regions of an input color space (or localized subspaces). The color mapping models may specify a mapping relationship or function (e.g., a mathematical relationship or function) between input colors (or input pixel values) within the localized subspaces and output colors (or output pixel values) in an output color space. In some embodiments, for example, color mapping models may be defined that map particular target colors in an input color space to specific output colors in an output color space. In some embodiments, for instance, color mapping models may be defined that map a pixel value of an object captured in an input image (e.g., of a stop sign or traffic signal having a distorted red color or foliage having a distorted yellowish color) to a pixel value of a memory color associated with that object (e.g., a standardized pixel value for “stop-light” or “stop-sign” red or “forest” green).

In some embodiments, the color mapping models may also map neighboring colors in the input color space, for example, in a localized region (or subspace) surrounding a target color (e.g., covering similar shades of red or green), to the output color space. In some embodiments, for example, the color mapping models may map colors that fall within a geometrically bounded region surrounding the target color (e.g., within a cuboid or ellipsoid centered about the target color) to the output color space. The contours of the bounded region may be provided by one or more geometric parameters, which for example, may affect a size, shape, and orientation of the region (e.g., in the input color space). Illustratively, a cuboid region centered about a target color may be defined by a pair of vertices from which the boundaries of the cuboid region may be established. As another example, an ellipsoid region centered about a target color may be defined by a triple of elliptical radii and a pair of orientation angles from which the boundaries of the ellipsoid region may be established.

In some embodiments, for example, the mapping relationship specified by a color mapping model may not only map a target color to a specific output color but also adjust neighboring colors to provide for a smooth overall color adjustment. In some embodiments, for example, the mapping relationship specified by a color mapping model may transition from maximal adjustment of the target color (e.g., to the specific output color) to minimal adjustment (e.g., no adjustment) of colors falling along the boundary of the color mapping model (e.g., of the localized region covered by the color mapping model). In some embodiments, for example, the color mapping model may define an interpolative function that can be used to determine an amount of adjustment for colors falling there between (e.g., between the target color and model boundary). In some embodiments, for instance, the color mapping model may specify a linear interpolation function that can be used to determine the amount by which colors within the subspace are to be adjusted. In some embodiments, the color mapping model may specify a weighted interpolation function that can be used to determine the amount by which colors within the subspace are to be adjusted. In some embodiments, the amount of adjustment specified by an interpolative function (e.g., a linear or weighted interpolation function) may be based on a distance between a color and the target color (e.g., in either vector or scalar terms) or a ratio of this distance to a distance between the specific output color and the target color.

In some embodiments, one or more color mapping models may be used to adjust the colors of an input image to produce a color adjusted output image. In some embodiments, for example, each pixel of the input image may be examined to see whether it falls within a localized region of a color mapping model. If it does, the pixel value may be adjusted according to the mathematical relationship specified by the color mapping model, but if not, the pixel value may remain unchanged. By defining and applying color mapping models for localized regions of an input color space (e.g., around particular target colors), color adjustments may be affected that would not be possible using a CCM (e.g., with respect to specific colors or regions within a color space). Moreover, because the color mapping models can be defined by relatively few parameters (e.g., a target color, a desired color, and/or a small number of geometric parameters and/or mapping function parameters), they are easier to handle than LUTs (e.g., easier to create, adapt, fine tune, inspect, validate, etc.) and less expensive to implement (e.g., as only a few parameters may be placed in memory). Furthermore, because the mapping of colors within a localized subspace may be provided by a mathematical relationship, the color mapping models can provide for more precision and control over color adjustments than LUTs, which are defined for a finite and fixed number of points.

In some embodiments, an optimization process may be performed to adjust the parameters of a color mapping model to obtain an optimized color mapping model. The mapping relationship defined by a color mapping model, for example, may produce undesirable contours (e.g., rapid color changes and/or color gaps or discontinuities) in an output color space. By way of example, a color mapping model may be defined to produce good color correction results for a particular image. A color mapping model, for instance, may be defined to adjust a color of an object that appears distorted in an input image to an associated memory color (e.g., as described above). The mapping relationship specified by the color mapping model may produce undesirable contours in the output color space. While the color mapping model may produce good color correction results for the particular image, it may not perform well when applied to other images on account of such contours, for example, producing visible artifacts in color corrected versions of those images.

In some embodiments, an optimization process may be performed to adjust the parameters of a color mapping model to obtain an optimized color mapping model that minimizes the amount or degree of contours in the output color space and/or visible artifacts produced thereby. For example, as discussed above, a color mapping model may be parameterized by a target color in an input color space, a corresponding output color in an output color space (e.g., to which the target color is mapped), one or more geometric parameters (e.g., defining the localized region of neighboring colors that are to be adjusted), and/or one or more mapping function parameters (e.g., governing the mapping relationship of the color mapping model). While these parameters may be manually adjusted, doing so can be quite laborious and may not result in an optimized color mapping model. Manual adjustment, for example, may involve applying the color mapping model to a set of sample images and adjusting parameters of the color mapping model through repeated trial and error (e.g., based on whether the resulting color corrected image is visually appealing or not). Furthermore, because the process is subjective in nature and limited by the set of sample images used (which may only cover a limited set of use cases), the resulting color mapping model may nevertheless be suboptimized.

In some embodiments, an optimization process may be performed that is computationally driven, for example, based on different measurements or metrics computer for a resulting color corrected image. In some embodiments, the optimization process may use synthetically generated test images that may be specially constructed to help produce artifacts in resulting color adjusted images and expose undesirable contours in the output color space. In some embodiments, for example, an optimization process may involve applying a color mapping model to a synthetic test image. In some embodiments, for instance, a synthetic test image may be generated that includes a smooth color ramp (or color gradient), which for example, may span the gamut of colors in the localized subspace covered by the color mapping model. The color adjusted test image (e.g., resulting from the application of the color mapping model to the synthetic test image) may undergo further processing to detect the presence of any artifacts produced therein.

In some embodiments, for example, the color adjusted test image may be subject to one or more processing operations, which may produce one or more metrics indicating the presence and/or absence of artifacts in the color adjusted image. The metrics may also reflect the amount and/or degree of undesirable contours in the output color space. In some embodiments, for example, the color adjusted test image may be passed through an edge detector (or be subject to an edge detection operation), which may produce edge strength and/or gradient direction metrics. The resulting metrics may be compared to certain threshold criterion (e.g., a threshold of visibility), based on which a determination may be made as to whether artifacts are present and/or absent from the color adjusted image. If one or more artifacts is detected, one or more model parameters may be adjusted, and the process may be repeated. This loop may continue until no visible artifacts are detected or further optimization is not possible.

In some embodiments, an optimization process may be performed on a collection of color mapping models, whereby the parameters of each color mapping model may be adjusted to obtain optimized color mapping models that minimize the amount or degree of contours in the output color space and/or visible artifacts collectively produced thereby. For example, in some cases, the effects of one color mapping model may impact whether undesirable contours and/or visible artifacts may be produced by or result from another color mapping model. While manual adjustment of a color mapping model may be possible, for example, using trial and error methods (as described above), manual adjustment of a collection of color mapping models is even more involved with the results even more likely to be suboptimized (for the reasons discussed above). In some embodiments, an optimization process, similar to that described above with regard to a single color mapping model, may be performed across multiple color mapping models.

In some embodiments, for example, an optimization process may involve applying a collection of color mapping models to one or more synthetic test images. The synthetic test images may be specially constructed to help expose undesirable contours in the resulting output color space and/or produce artifacts in the resulting color adjusted image. In some embodiments, for instance, synthetic test images may be generated that include smooth color ramps (or color gradients), which for example, may span a gamut of colors and collectively cover the target colors of each color mapping model in the collection. The color adjusted test images (e.g., resulting from the application of the color mapping model to the synthetic test image) may undergo further processing to detect the presence of any artifacts produced therein. In some embodiments, for example, the color adjusted test images may be subject to one or more processing operations, which may produce one or more metrics indicating the presence and/or absence of artifacts in the color adjusted images. The metrics may also reflect the amount and/or degree of undesirable contours in the output color space. In some embodiments, for example, the color adjusted test images may be passed through an edge detector (or be subject to an edge detection operation), which may produce edge strength and/or gradient direction metrics. The resulting metrics may be compared to certain threshold criterion (e.g., a threshold of visibility), based on which a determination may be made as to whether artifacts are present and/or absent in a color adjusted image. If one or more artifacts is detected, one or more parameters of one or more color mapping models may be adjusted, and the process may be repeated. This loop may continue until no visible artifacts are detected or further optimization is not possible. The optimization processes disclosed herein may greatly reduce the time and effort spent on developing color mapping model(s), for example, as compared to manual approaches (e.g., involving trial and error). Furthermore, because the optimization processes are metric driven, using specially constructed synthetic test images, they may also produce superior results.

The systems, methods, and techniques described herein may be used, for example and without limitation, by non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, systems implementing one or more language models—such as large language models (LLMs), systems for preforming generative AI operations, augmented reality content, or mixed reality content, systems for performing light transport simulation, systems for performing collaborative content creation for 3D assets, systems implemented at least partially using cloud computing resources, and/or other types of systems.

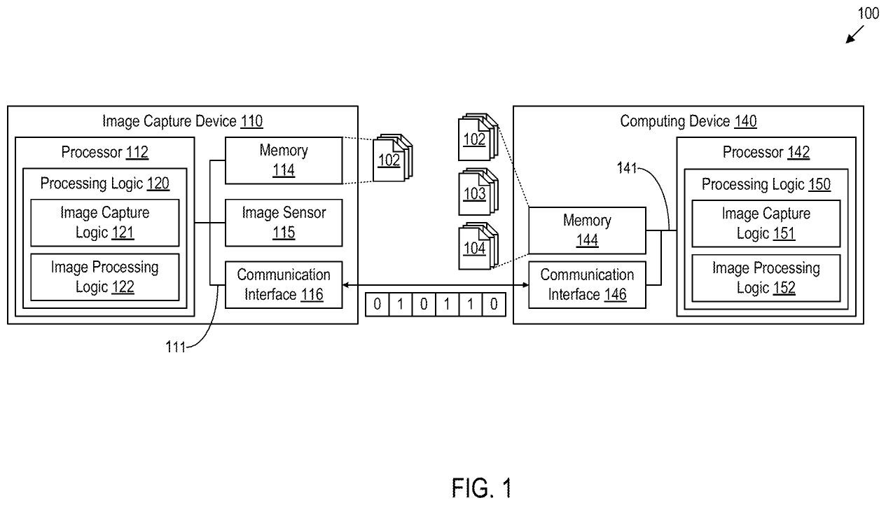

FIG. 1 illustrates an imaging system 100 in accordance with at least one embodiment of the present disclosure. Imaging system 100 may represent any system that can be used to capture and process digital images (e.g., still images, multiple simultaneously captured images, videos comprising a sequence of image frames, etc.). Imaging system 100 may take a variety of forms, including for example, a digital camera, an automotive, aerial, or robotic vision system, a medical imaging system, a security or surveillance system, a personal computer or laptop, or other system that may capture and process digital images.

In some embodiments, imaging system 100 may include an image capture device 110 and a computing device 140. The image capture device 110 may be used to capture one or more images (e.g., of a physical scene illuminated by one or more illuminants), which in turn, may be provided to the computing device 140 for further processing. In some embodiments, the image capture device 110 may perform some initial processing (or pre-processing) of the captured images before providing them to computing device 140. The computing device 140 may receive captured images from image capture device 110 and process them (further). In some embodiments, for example, the computing device 140 may perform a color correction process, or series of color correction processes, on the images received from image capture device 110 to produce color adjusted output images.

In some embodiments, for example, computing device 140 may perform an initial color correction process to adjust the colors of received images to produce a more accurate color representation of a scene captured in the image. In some embodiments, for example, computing device 140 may perform an initial color correction process that accounts for the unique properties of the image capture device 110 used to capture the image. In some embodiments, the computing device 140 may employ a CCM or LUT-based approach to perform the initial color correction process. In some embodiments, computing device 140 may perform one or more additional color correction processes to adjust the colors of the images to better suit the aesthetic preferences of a user and/or to produce better results in downstream processing of the images. By way of example, in some embodiments, computing device 140 may perform a color correction process to adjust the skin tone of individuals captured in an image, enhance certain colors in a landscape image (e.g., so that the leaves on trees are a vibrant green), and/or adjust the color of certain objects to have an expected memory color. As another example, in some embodiments, imaging system 100 may be comprised in a computer vision system, such as an automotive vision system, which may process images to detect and/or identify one or more objects captured therein. In such embodiments, computing device 140 may perform a color correction process to adjust the colors of images (e.g., received from image capture device 110) so that the color of certain objects that may appear within the images may more closely match what is expected so that the objects may be more readily detected and/or identified by the vision system (e.g., by neural networks thereof). In some embodiments, the additional color correction process performed by computing device 140 may involve applying one or more color mapping models to the images. The color mapping models may provide for the adjustment (or warping) of specific colors within a localized region of an input color space, as described in further detail herein.

Image capture device 110 may take a variety of forms, including for example, a digital camera, a video camera, or a camera or sensor module that may be connected to, or integrated within, another device (e.g., a mobile phone, laptop computer, robot, aerial drone, smart appliance, automobile, etc.). The image capture device 110 may include various optical components (e.g., a lens, mirror, shutter, etc.) and one or more image sensor(s) 115 that the image capture device 110 may use to capture an image of a scene. The image sensor(s) 115 may include any of a variety of optical sensors, including a charge-coupled device (CCD) or an active-pixel sensor (APS), such as a complementary metal-oxide-semiconductor (CMOS) sensor. The image sensor 115 may contain an array of picture elements (pixels) made up of photosensitive elements (e.g., photo-diodes, phototransistors, photo-gates, or the like), micro-lenses, and/or micro-electronic components (e.g., amplifying and switching components). The photosensitive elements may receive and convert electromagnetic energy (e.g., visible light) focused upon the elements (e.g., through a lens or other optics) into a digital signal (or an analog signal that is converted into a digital signal using an analog-to-digital converter (ADC)) that can be processed and/or stored by the image capture device 110.

The image sensor(s) 115 may also include a color filter array (CFA), composed of a mosaic of tiny color filters (e.g., polymer filters), placed over the pixel array. Each color filter may reflect and/or absorb undesired color wavelengths such that each image sensor pixel is sensitive to a specific color wavelength. A Bayer filter, for example, may isolate red, green, and blue wavelengths using alternating red (R) and green (G) filters for odd rows and alternating green (G) and blue (B) filters for even rows. In other cases, a CFA can be made with complementary color filters such as cyan, magenta, and yellow, or any other color system. A full-color image (e.g., with intensities of all colors represented at each pixel) may be reconstructed from a captured image by performing a demosaicing algorithm (also known as, color reconstruction or CFA interpolation).

The image capture device 110 may also include one or more processor(s) 112 (e.g., a controller, digital signal processor (DSP), image signal processor (ISP), etc.) and one or more memory(ies) 114 (e.g., volatile or non-volatile memory(ies)). The processor(s) 112, memory(ies) 114, and image sensor(s) 115 may be coupled to and communicate over one or more communication bus(es) 111. The image capture device 110 may also include one or more communication interface(s) 116 coupled to communication bus(es) 111, which the processor(s) 112 can use to communicate with other devices, such as computing device 140. The image capture device 110, for example, may include a Camera Serial Interface (CSI), an Ethernet or Wi-Fi interface, and/or other communication interface over which data can be exchanged with other devices, such as computing device 140.

The processor(s) 112 may include processing logic 120 that can be used (e.g., executed by processor(s) 112) to perform different processes and/or operations. In some embodiments, the processing logic 120 may include image capture logic 121, which may be used to capture and store one or more image(s) using image sensor(s) 115, for example, as image data 102 on volatile and/or non-volatile memory(ies) 114. In some embodiments, processor(s) 112 may also include image processing logic 122, which may be used to process an image (e.g., as part of an image capture process performed by image capture logic 121, a post-capture image enhancement process, or some other process).

In some embodiments, for instance, processor(s) 112 may use image capture logic 121 to control image sensor(s) 115 (e.g., by exchanging control signaling over communication bus 111) and receive data output from the image sensor(s) 115 (e.g., over communication bus 111). In some embodiments, for example, image capture logic 121 may direct one or more image sensor(s) 115 to capture an image (e.g., of a physical scene illuminated by one or more illuminants), and in response, the image sensor(s) 115 may return data corresponding to the determined intensity of light (e.g., as measured by the photosensitive elements of the image sensor(s) 115). Image capture logic 121 may store the sensor data returned by image sensor(s) 115, for example, in volatile and/or non-volatile memory(ies) 114. In some embodiments, for example, image capture logic 121 may store raw sensor data (or raw image data) comprising one or more raw image(s) (e.g., as one or more raw image file(s)).

In other embodiments, image capture device 110 may process the raw image(s) further to produce captured image(s) that may be stored, in place of or in addition to the raw sensor data, as captured image data (e.g., as one or more captured image file(s)). In some embodiments, for example, image capture logic 121 may use image processing logic 122 to process the raw image(s) to produce captured image(s), which the image capture logic 121 may store in memory(ies) 114. In some embodiments, for example, image processing logic 122 may be used to process the raw image(s) to produce captured image file(s) that conform to a particular file format. In some embodiments, image processing logic 122 may also (or alternatively) be used to modify or enhance the raw image(s) in some way to produce the captured image(s). By way of example, in some embodiments, image processing logic 122 may be used to perform a demosaicing process to convert raw image(s) into full-color image(s). In some embodiments, the raw image(s) may not be processed further by image capture device 110 (e.g., before they are provided to computing device 140).

Depending on the embodiment, image data 102 may be or include raw sensor data and/or captured image data, comprising one or more raw image file(s) and/or captured image file(s). Each image file (e.g., raw image file or captured image file) may comprise a set of pixels forming an image (e.g., a raw image or captured image). Each image may have a size (e.g., reflecting a resolution of the image) that may be measured in terms of a quantity of pixels. An image, for example, may have a resolution expressed in terms of a width and height of pixels, for example, 720×480 (e.g., Standard-Definition (SD)), 1920×1800 (e.g., High Definition (HD)), 3840×2160 (e.g., 4K Ultra High Definition (4K UHD)), 7680×4320 (e.g., 8K Ultra High Definition (8K UHD)). In some embodiments, an image file may also contain metadata regarding an image and its capture. The metadata, for example, may include details about the image (e.g., resolution, color space, etc.), about image capture device 110 and its settings when the image(s) were captured (e.g., make and model, orientation, aperture, shutter speed, focal length, metering mode, and ISO speed), and/or other relevant information (e.g., date, time, and/or location of capture).

An image file may conform to a particular file format, which may define the information conveyed for each pixel of the image, including for example, the number and type of values conveyed for each pixel (e.g., raw pixel sensor values, RGB or YUV values, etc.) and corresponding value size (e.g., 8-bit, 10-bit, etc.) indicating the range that a particular value can take (e.g., 0-255, 0-1023, etc.). An image, for example, may be stored in a “RAW” format (e.g., RAW8, RAW16, etc.) where each image pixel contains the raw sensor output of a corresponding sensor pixel (e.g., of an image sensor 115) that may be represented by a particular number of bits (e.g., 8-bit, 16-bit, 24-bit, etc.). As another example, an image may be stored in an “RGB” format (e.g., RGB24 (or RGB 8:8:8), RGB48 (or RGB 16:16:16), etc.) where each image pixel has an associated red (R), green (G), and blue (B) value, each of which may be represented by a particular number of bits (e.g., 8-bits, 16-bits, etc.).

In some embodiments, image capture logic 121 may use image processing logic 122 to process raw sensor data (e.g., a raw image) to produce an image that conforms to a particular format (e.g., an RGB24 image). In some cases, this may involve reconstructing a full-color image (e.g., where each image pixel comprises an R, G, and B value) from a raw image (e.g., where each image pixel comprises a single value of a corresponding sensor pixel). Metadata associated with a raw image, for example, may indicate the color filter array (CFA) (e.g., a Bayer filter, CYGM filter, etc.) that was used to capture the raw image, which image processing logic 122 can use to determine the color conveyed by a specific sensor pixel. With this information, the image processing logic 122 may be able to perform a demosaicing algorithm to reconstruct a full-color image, which can be stored in the desired file format. The image, for instance, may be stored as an RGB image, where each pixel has an associated red (R), green (G), and blue (B) value (e.g., an RGB24 image (or RGB 8:8:8 image) where each color is represented by 8-bits of data). As another example, in some embodiments, image processing logic 122 may be used to convert an image from one color model or domain to another (e.g., an RGB model to a YUV model). By way of example, image capture logic 122 may convert an RGB image, where pixel color is represented by red (R), green (G), and blue (B) component values, to a YUV image, where pixel color is represented by a lumaticity (or luma) component (Y) and a pair of chromaticity components (U and V), reflecting a relative redness and relative blueness of the pixel.

In some embodiments, a color calibration process can be performed to characterize the color response characteristics of image capture device 110 and image sensor(s) 115 and produce color calibration data that reflects these response characteristics. The color calibration data can then be used to assist with processing images captured by the image capture device 110 and image sensor(s) 115 (e.g., to perform color correction processes on the images). The color calibration process, for example, may involve measuring the response of image sensor(s) 115 with respect to a reference scene or object, having one or more known colors (e.g., middle-gray, primary colors, etc.) and/or illuminated by a known illuminant (or a set of known illuminants). In some embodiments, for example, a color calibration process may involve capturing images of one or more color cards, for instance, a white balance card or a grey card. In some embodiments, the images may be captured using different forms of artificial lighting (e.g., incandescent, fluorescent, or LED lighting) with varying correlated color temperatures (or “color temperatures”). The captured images may be processed by the image capture device 110 to determine a set of one or more color correction factors that may be used to adjust (or correct) the colors of an image (e.g., of other images captured using image capture device 110 and/or sensor(s) 115) to produce a more color-accurate representation of a scene captured in the image. In some embodiments, for example, the captured images may be used to generate a color correction matrix that can be applied to adjust (or correct) the colors of an image. The image capture device 110 may provide this color calibration data (e.g., a set of color correction factors, or color correction matrix) to computing device 140. In some embodiments, the images captured by image capture device 110 as part of the color calibration process may be sent to and processed by computing device 140, for example, to determine the set of color correction factors or color correction matrix.

The computing device 140 may include one or more processor(s) 142 (e.g., a digital signal processor (DSP), image signal processor (ISP) etc.), memory(ies) 144 (e.g., volatile or non-volatile memory), and communication interface(s) 146. The processor(s) 142, memory(ies) 144, and communication interface(s) 146 may be coupled to and communicate over communication bus(es) 141. The processor(s) 142 can use communication interface(s) 146 to communicate with other devices such as image capture device 110. The computing device 140, for example, may include a Camera Serial Interface (CSI), an Ethernet or Wi-Fi interface, and/or other communication interface over which data can be exchanged with other devices, such as computing device 140. The processor(s) 142 may include processing logic 150 that can be used (e.g., executed by processor(s) 142) to perform different processes and/or operations. In some embodiments, for example, processor(s) 142 may include image capture logic 151 and image processing logic 152.

The image capture logic 151 may be used by processor(s) 142 to capture image data from an image source such as image capture device 110. The image capture logic 151, for example, may be used to acquire image data 102 from image capture device 110 via communication interface(s) 146, which may be stored in volatile and/or non-volatile memory(ies) 144 for further processing. In some embodiments, computing device 140 may externally manage the image capture device 110 and control operation thereof. In some embodiments, for example, image capture logic 151 may initiate an image capture process on image capture device 110 (e.g., by exchanging control signaling with image capture device 110 over communication interface(s) 126) and may receive image data 102 from image capture device 110 in response (e.g., via communication interface(s) 126).

Depending on the embodiment, image data 102 may be or include sensor data and/or captured image data, comprising one or more raw image file(s) and/or captured image file(s). Each image file (e.g., raw image file or captured image file) may comprise a set of pixels forming an image (e.g., a raw image or captured image). Each image may have a size (e.g., reflecting a resolution of the image) that may be measured in terms of a quantity of pixels. An image, for example, may have a resolution expressed in terms of a width and height of pixels, for example, 720×480 (e.g., Standard-Definition (SD)), 1920×1800 (e.g., High Definition (HD)), 3840×2160 (e.g., 4K Ultra High Definition (4K UHD)), 7680×4320 (e.g., 8K Ultra High Definition (8K UHD)). In some embodiments, an image file may also contain metadata regarding an image and its capture. The metadata, for example, may include details about the image (e.g., resolution, color space, etc.), about image capture device 110 and its settings when the image(s) were captured (e.g., make and model, orientation, aperture, shutter speed, focal length, metering mode, and ISO speed), and/or other relevant information (e.g., date, time, and/or location of capture). Image capture logic 151 may be used to parse image data 102 to obtain images and associated metadata contained therein.

In some embodiments, image capture logic 151 may be used to obtain color calibration data from image capture device 110 that may reflect the unique response characteristics of its image sensor(s) 115. In some embodiments, for example, image capture logic 151 may request color calibration data from image capture device 110 (e.g., by exchanging control signaling with image capture device 110 over communication interface(s) 126) and may receive color calibration data from image capture device 110 in response (e.g., via communication interface(s) 126). In some embodiments, the color calibration data may include a set of color correction factors or a color correction matrix that may reflect the response characteristics of image capture device 110 and/or its sensor(s) 115, which can be used to adjust (or correct) the colors of images captured from image capture device 110 to produce a more color-accurate representation of a scene captured therein. In some embodiments, the calibration data may comprise one or more images captured by image capture device 110 as part of a color calibration process, for example, images of a reference scene or object (e.g., color cards, such as white balance cards or grey cards) captured using sensor(s) 115 thereof. In some embodiments, the computing device 140 may process the images (e.g., using image processing logic 152) to determine a set of color calibration factors or color correction matrix. The color calibration data may be stored (e.g., in memory(ies) 144) for later use by the computing device 140 (e.g., in performing one or more color correction processes).

In some embodiments, image processing logic 152 may be used to perform one or more color correction or color adjustment processes to produce a color adjusted output image. In some embodiments, processing logic 152 may store the color adjusted image as color adjusted image data 103 (e.g., as an image file in memory(ies) 144). In some embodiments, the color adjusted image may be provided for further downstream processing (e.g., to an object detection and/or identification process).

In at least one embodiment, for example, image processing logic 152 may be used to perform a color correction process to adjust the colors of an image (e.g., captured by image capture logic 151) to produce a more color-accurate representation of a scene captured in the image. In some embodiments, for example, image processing logic 152 may be used to may perform color correction to adjust the colors of an image to account for the unique properties of the image capture device 110 from and/or by which an image may be captured. The images produced by image capture device 110, for example, may be in a unique color space. That is, the images produced by image capture device 110 may reflect the unique response characteristics of the image capture device 110, for example, on account of errors or biases in its image sensor(s) 115 due to fabrication and/or processing variations (e.g., pixel response variations, color filter misalignment, variations in filter transmission coefficients, etc.), and/or on account of the optical components of the image capture device 110. In some embodiments, image processing logic 152 may be used to perform color correction to adjust the colors of a captured image to match a standardized color space like CIELAB or CIELUV, which may allow for a more faithful color rendition of the captured image when reproduced (e.g., displayed).

In some embodiments, image processing logic 152 may be used to perform a color correction process to adjust the colors of an image (e.g., a raw image or captured image) to better suit the aesthetic preferences of a user. Image processing logic 152, for example, may be used to perform a color correction process to adjust the skin tone of individuals captured in an image or enhance certain colors in a scenic image (e.g., so that the leaves on a tree are a vibrant green). As another example, certain objects, such as a stop sign, may be strongly associated with a particular “memory color” (e.g., in terms of psychological perception by an individual). When such objects are captured in an image, however, they may not present with this color. The color of a stop sign, for example, may appear distorted due to glare or overexposure. Image processing logic 152 may be used to perform a color correction process to adjust the colors of the image so that these objects have the expected memory color.

In some embodiments, image processing logic 152 may be used to perform a color correction process to adjust the colors of an image (e.g., a raw image or captured image) to produce better results in downstream processing of the image, for example, by a computer vision system (or other image processing systems). As an illustrative example, use of vision systems in certain applications, such as automotive or aeronautical applications (e.g., to support self-driving vehicles or self-flying drones or aircraft), may have serious safety implications. In such applications, it may be critical for the vision system to be able to accurately detect and/or identify certain objects, such as traffic lights or other traffic signals (e.g., cross-walk signals, etc.). But bright light sources, such as these, may appear distorted when captured using cameras or sensors of the vision systems, such that the objects may not be consistently detected and/or identified when subsequently processed by the vision systems. The distortion may be particularly acute in cameras or sensors having a high dynamic range, which are commonly used in automotive and aeronautical vision systems. In some embodiments, image processing logic 152 may be used to perform color correction to adjust the color of an image so that objects in the image may more closely match what is expected by a vision system (e.g., by neural networks thereof) so that they may be more readily identified and detected by the vision system.

Image processing logic 152 may employ a number of different techniques to adjust the colors of an input image to affect a desired color correction. In some embodiments, for example, image processing logic 152 may use a color correction matrix (CCM) to adjust the colors of an image. A CCM, for example, may be defined that specifies a linear relationship between input pixel values of an input image and output pixel values of a (color adjusted) output image. Each pixel of an input image, for instance, may be multiplied by the CCM to obtain a corresponding output pixel of the color adjusted output image. By way of example, each pixel of an RGB input image (e.g., comprising an R, G, and B value) may be multiplied by a 3×3 CCM (e.g., specifying linear weighting coefficients a₁₁ . . . a₃₃) to obtain a corresponding output pixel of an adjusted output image (e.g., comprising adjusted values R′, G′, and B′). This color correction, for example, may be expressed as follows:

$$[ \begin{matrix}{R}^{′} \\ {G}^{′} \\ {B}^{′}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R \\ G \\ B\end{matrix} ] \qquad Eq . 1$$

In some embodiments, image processing logic 152 may use a look-up table (LUT) to adjust the colors of an input image (e.g., a captured image). A look-up table, for example, may be defined that maps each possible pixel value (or ranges of pixel values) of an input color space (e.g., a sensor color space) to an adjusted pixel value in an output color space (e.g., a standardized color space). The size and dimensionality of the LUT may vary depending on the embodiment and its application. The dimensionality of the LUT, for example, may depend on the number of channels in the input color space (e.g., the number of color channels of a pixel in the input color space), and its size may reflect the number of sample points (or intervals) in each dimension. By way of example, a three-dimensional (3D) LUT of size n×n×n (e.g., 17×17×17, 33×33×33, or 65×65×65) may define a mapping between an RGB or YUV input color space, at n sample points in each dimension (e.g., in an R, G, and B dimension, or a Y, U, and V dimension), and an RGB or YUV output color space (e.g., where each entry in the 3D LUT specifies an adjusted RGB or YUV value triplet).

In applying a LUT, each pixel of an input image may be used to index into the LUT to obtain a value of a corresponding output pixel. For example, each pixel of an input RGB image (e.g., having values R, G, and B) may be used to index into a 3D LUT to obtain a value of a corresponding output pixel of an adjusted RGB image (e.g., adjusted values R′, G′, and B′). In some cases, an input pixel value may fall between sample points (e.g., in each of one or more dimensions), and in such cases, interpolation may be used to obtain the output pixel value. In some embodiments, for example, a nearest-neighbor interpolation technique may be used to find and return the nearest value in the 3D LUT, while in other embodiments, more complex interpolation algorithms (e.g., trilinear interpolation, or higher-order interpolation techniques).

In some embodiments, image processing logic 152 may use one or more color mapping models to adjust the colors of an input image. In some embodiments, for example, color mapping models may be used to provide for color adjustment (or warping) of specific colors within an input color space. In some embodiments, for example, one or more color mapping models may be defined for localized regions of an input color space (or localized subspaces). In some embodiments, the color mapping models may specify a mapping relationship or function (e.g., a mathematical relationship or function) between input colors (e.g., input pixel values or components thereof) within the localized subspaces and output colors (e.g., output pixel values or components thereof) in an output color space. In some embodiments, for example, color mapping models may be defined that map particular target colors in an input color space to specific output colors in an output color space. In some embodiments, for instance, color mapping models may be defined that map a color (e.g., a pixel value) of an object captured in an input image (e.g., of a stop sign or traffic signal having a distorted red color or foliage having a distorted yellowish color) to a memory color associated with that object (e.g., a standardized pixel value for “stop-light” or “stop-sign” red or “forest” green).

In some embodiments, the color mapping models may also map neighboring colors in the input color space, for example, in a localized region (or subspace) surrounding a target color (e.g., covering similar shades of red or green), to the output color space. In some embodiments, for example, the color mapping models may map colors that fall within a geometrically bounded region surrounding the target color (e.g., within a cuboid or ellipsoid centered about the target color) to the output color space. The contours of the bounded region may be provided by one or more geometric parameters, which for example, may affect a size, shape, and orientation of the region (e.g., in the input color space).

In some embodiments, for example, the relationship specified by a color mapping model may not only map a target color to a specific output color but also adjust neighboring colors to provide for a smooth overall color adjustment. In some embodiments, for example, the mapping relationship specified by the color mapping models may transition from maximal adjustment of the target color (e.g., to the specific output color) to minimal adjustment (e.g., no adjustment) of colors falling along the boundary of the color mapping model (e.g., of the localized region covered by the color mapping model). In some embodiments, for example, the color mapping model may define an interpolative function that can be used to determine an amount of adjustment for colors falling there between (e.g., between the target color and model boundary). In some embodiments, for instance, the color mapping model may specify a linear interpolation function that should be used to determine the amount by which colors within the subspace are to be adjusted. In some embodiments, for example, the linear interpolation function may determine the amount by which colors are to be adjusted based on a distance of a color from the target color (e.g., in either vector or scalar terms). In some embodiments, the color mapping model may specify a weighted interpolation function that applies a weighting function (e.g., a power function) to determine the amount by which colors within the subspace are to be adjusted. In some embodiments, for example, the weighting function may determine the amount of adjustment based on a distance of a color from the target color (e.g., in either vector or scalar terms).

In some embodiments, image processing logic 152 may use one or more defined color mapping models to adjust the colors of an input image to produce a color adjusted output image. In some embodiments, for example, each pixel of the input image may be examined to see whether it falls within a localized region of a color mapping model. If it does, the pixel value may be adjusted according to the mathematical relationship specified by the color mapping model, but if not, the pixel value may remain unchanged. By defining and applying color mapping models for localized regions of an input color space around particular target colors, color adjustments may be affected that would not be possible using a CCM (e.g., with respect to specific colors or regions within a color space). Moreover, because the color mapping models can be defined by relatively few parameters (e.g., a target color, a desired color, and/or a small number of geometric parameters and/or mapping function parameters), they are easier to handle than LUTs (e.g., easier to create, adapt, fine tune, inspect, validate, etc.) and less expensive to implement (e.g., as only a few parameters may be placed in memory). Furthermore, because the mapping of colors within a localized subspace may be provided by a mathematical relationship, the color mapping models can provide for more precision and control over color adjustments than LUTs, which are defined for a finite and fixed number of points.

As an illustrative example, in some embodiments, a color mapping model may be defined that maps a target color in a YUV input color space to a specific output color in a YUV output color space. In at least one embodiment, the target color may be specified in terms of its component values, (Y₀, U₀, V₀), and the specific output color may be specified in terms of the amount of adjustment needed to produce the specific output color, for example, with respect to each component value, (dY₀, dU₀, dV₀). In at least one embodiment, the color mapping model may also map neighboring colors in the input color space, for example, falling within a cuboid region centered about the target color, to the output color space. In at least one embodiment, a cuboid region centered about the target color may be defined by a pair of vertices (Y₁, U₁, V₁) and (Y₂, U₂, V₂).

In some embodiments, the color mapping model may specify a linear interpolation function for mapping colors within the cuboid region of the input color space to the output color space. In some embodiments, the color mapping model may specify a linear interpolation function that is based on a distance between a particular color, having component values (Y, U, V), and the target color (e.g., in each component direction, or in terms of an absolute magnitude). In some embodiments, for example, the color mapping model may specify a linear interpolation function that is based on a ratio of the distance between a particular color and the target color (e.g., in each component direction, or in terms of an absolute magnitude) and the distance between the specific output color and the target color (e.g., in each component direction, or in terms of an absolute magnitude). In some embodiments, the color mapping model may specify a linear interpolation function that is based on a ratio of the square distance between a particular color and the target color (e.g., in terms of an absolute magnitude), and the square distance between the specific output color and the target color (e.g., in terms of an absolute magnitude).

In at least one embodiment, for instance, the color mapping model may specify a linear interpolation function that may be expressed as follows:

$$dY = ( 1 - ( \frac{{Y}_{0} - Y}{{Y}_{0} - {Y}_{1}} ) ) {dY}_{0} , \qquad Eq . 2$$

$$if ( {Y}_{1} < Y < {Y}_{0} )$$

$$dY = ( 1 - ( \frac{{Y}_{0} - Y}{{Y}_{0} - {Y}_{2}} ) ) {dY}_{0} , \qquad Eq . 3$$

$$if ( {Y}_{0} < Y < {Y}_{2} )$$

$$dU = ( 1 - ( \frac{{U}_{0} - U}{{U}_{0} - {U}_{1}} ) ) {dU}_{0} , \qquad Eq . 4$$

$$if ( {U}_{1} < U < {U}_{0} )$$

$$dU = ( 1 - ( \frac{{U}_{0} - U}{{U}_{0} - {U}_{2}} ) ) {dU}_{0} , \qquad Eq . 5$$

$$if ( {U}_{0} < U < {U}_{2} )$$

$$dV = ( 1 - ( \frac{{V}_{0} - V}{{V}_{0} - {V}_{1}} ) ) {dV}_{0} , \qquad Eq . 6$$

$$if ( {V}_{1} < V < {V}_{0} )$$

$$dV = ( 1 - ( \frac{{V}_{0} - V}{V - {V}_{2}} ) ) {dV}_{0} , \qquad Eq . 7$$

$$if ( {V}_{0} < V < {V}_{2} )$$

where the amount by which a particular color is to be adjusted with respect to each component value is (dY, dU, dV).

In some embodiments, the color mapping model may specify a weighted interpolation function for mapping colors that fall within the cuboid region of the input color space to the output color space (e.g., instead of a linear interpolation function). In some embodiments, for example, the color mapping model may specify a weighted interpolation function that is based on a distance between a particular color, having component values (Y, U, V), and the target color (e.g., in each component direction, or in terms of an absolute magnitude). In some embodiments, for example, the color mapping model may specify a weighted interpolation function that is based on a ratio of the distance between a particular color and the target color (e.g., in each component direction, or in terms of an absolute magnitude) and the distance between the specific output color and the target color (e.g., in each component direction, or in terms of an absolute magnitude). In some embodiments, the color mapping model may specify a linear interpolation function that is based on a ratio of the square distance between a particular color and the target color (e.g., in terms of an absolute magnitude), and the square distance between the specific output color and the target color (e.g., in terms of an absolute magnitude). In some embodiments, the weighted interpolation function may be or include a spatial density function (e.g., a power function, an inverse power function, or other spatial density function).

In at least one embodiment, for instance, the color mapping model may specify a weighted interpolation function that may be expressed as follows:

$$dY = ( 1 - {( \frac{{Y}_{0} - Y}{{Y}_{0} - {Y}_{1}} )}^{k} ) {dY}_{0} , \qquad Eq . 8$$

$$( {Y}_{1} < Y < {Y}_{0} )$$

$$dY = ( 1 - {( \frac{{Y}_{0} - Y}{{Y}_{0} - {Y}_{2}} )}^{k} ) {dY}_{0} , \qquad Eq . 9$$

$$( {Y}_{0} < Y < {Y}_{2} )$$

$$dU = ( 1 - {( \frac{{U}_{0} - U}{{U}_{0} - {U}_{1}} )}^{k} ) {dU}_{0} , \qquad Eq . 10$$

$$( {U}_{1} < U < {U}_{0} )$$

$$dU = ( 1 - {( \frac{{U}_{0} - U}{{U}_{0} - {U}_{2}} )}^{k} ) {dU}_{0} , \qquad Eq . 11$$

$$( {U}_{0} < U < {U}_{2} )$$

$$dV = ( 1 - {( \frac{{V}_{0} - V}{{V}_{0} - {V}_{1}} )}^{k} ) {dV}_{0} , \qquad Eq . 12$$

$$( {V}_{1} < V < {V}_{0} )$$

$$dV = ( 1 - {( \frac{{V}_{0} - V}{V - {V}_{2}} )}^{k} ) {dV}_{0} , \qquad Eq . 13$$

$$( {V}_{0} < V < {V}_{2} )$$

where k may be a strength of correction factor, which for example, may take a value of 1, ½, ⅓, ¼, ⅕ or other value less than one, and the amount by which a particular color is to be adjusted with respect to each component value is (dY, dU, dV).

In applying one of the color mapping models described above, to correct or adjust the color of an input image, image processing logic 152 may examine each pixel of the input image to determine whether it falls within the cuboid region covered by the color mapping model. In some embodiments, for example, image processing logic 152 may determine whether a value of a particular pixel, (Yₚᵢₓ, Uₚᵢₓ, Vₚᵢₓ) satisfies the following relationships:

$$( Y 1 < {Y}_{pix} < Y 2 ) \qquad Eq . 14$$

$$( U 1 < {U}_{pix} < U 2 ) \qquad Eq . 15$$

$$( V 1 < {V}_{pix} < V 2 ) \qquad Eq . 16$$

If it does fall within the cuboid region, for example, if Equations 14-16 are satisfied, the image processing logic 152 may determine an amount of adjustment, for example, using Equations 2-7 or Equations 8-13, and may adjust the pixel value accordingly to obtain the output pixel:

$$( {Y}_{pix} + dY , {U}_{pix} + dU , {V}_{pix} + dV ) \qquad Eq . 17$$

As another illustrative example, in some embodiments, a color mapping model may be defined that maps a target color in a YUV input color space to a specific output color in a YUV output color space. In at least one embodiment, the target color may be specified in terms of its component values, (Y₀, U₀, V₀), and the specific output color may be specified in terms of the amount of adjustment needed to produce the specific output color, for example, with respect to each component value, (dY₀, dU₀, dV₀). In at least one embodiment, the color mapping model may also map neighboring colors in the input color space, for example, falling within an ellipsoid region centered about the target color, to the output color space. In at least one embodiment, the ellipsoid region may be defined by elliptical radii (A, B, C). In some embodiments, the ellipsoid region may be further defined by a pair of orientation angles, for example, polar and azimuthal angles (θ, φ), which may affect a rotation of the ellipsoid region within the input color space.

In some embodiments, the color mapping model may specify a linear interpolation function for mapping colors within the ellipsoid region of the input color space to the output color space. In some embodiments, the color mapping model may specify a linear interpolation function that is based on a distance between a particular color, having component values (Y, U, V), and the target color (e.g., in each component direction, or in terms of an absolute magnitude). In some embodiments, for example, the color mapping model may specify a linear interpolation function that is based on a ratio of the distance between a particular color and the target color (e.g., in each component direction, or in terms of an absolute magnitude) and the distance between the specific output color and the target color (e.g., in each component direction, or in terms of an absolute magnitude). In some embodiments, the color mapping model may specify a linear interpolation function that is based on a ratio of the square distance between a particular color and the target color (e.g., in terms of an absolute magnitude), and the square distance between the specific output color and the target color (e.g., in terms of an absolute magnitude).

In at least one embodiment, for instance, a square distance between a particular color and the target color may be expressed as:

$$DE = {( \frac{Y - {Y}_{0}}{A} )}^{2} + {( \frac{U - {U}_{0}}{B} )}^{2} + {( \frac{V - {V}_{0}}{C} )}^{2} \qquad Eq . 18$$

and a square distance between a specific output color and the target color may be expressed as:

$${DE}_{0} = {( \frac{{dY}_{0}}{A} )}^{2} + {( \frac{{dU}_{0}}{B} )}^{2} + {( \frac{{dV}_{0}}{C} )}^{2} \qquad Eq . 19$$

and a ratio of the distance between the particular color and the target color and the distance between the specific output color and the target color may be expressed as:

$$r = \frac{DE}{{DE}_{0}} \qquad Eq . 20$$

The linear interpolation function, in turn, may be expressed as follows:

$$dY = ( 1 - r ) {dY}_{0} \qquad Eq . 21$$

$$dU = ( 1 - r ) {dU}_{0} \qquad Eq . 22$$

$$dV = ( 1 - r ) {dV}_{0} \qquad Eq . 23$$

where the amount by which a particular color is to be adjusted with respect to each component value is (dY, dU, dV).

In some embodiments, the color mapping model may specify a weighted interpolation function for mapping colors that fall within the ellipsoid region of the input color space to the output color space (e.g., instead of a linear interpolation function). In some embodiments, for example, the color mapping model may specify a weighted interpolation function that is based on a distance between a particular color, having component values (Y, U, V), and the target color (e.g., in each component direction, or in terms of an absolute magnitude). In some embodiments, for example, the color mapping model may specify a weighted interpolation function that is based on a ratio of the distance between a particular color and the target color (e.g., in each component direction, or in terms of an absolute magnitude) and the distance between the specific output color and the target color (e.g., in each component direction, or in terms of an absolute magnitude). In some embodiments, the color mapping model may specify a linear interpolation function that is based on a ratio of the square distance between a particular color and the target color (e.g., in terms of an absolute magnitude), and the square distance between the specific output color and the target color (e.g., in terms of an absolute magnitude). In some embodiments, the weighted interpolation function may be or include a spatial density function (e.g., a power function, an inverse power function, or other spatial density function).

In at least one embodiment, for instance, a square distance between a particular color and the target color may be expressed as:

$$DE = {( \frac{Y - {Y}_{0}}{A} )}^{2} + {( \frac{U - {U}_{0}}{B} )}^{2} + {( \frac{V - {V}_{0}}{C} )}^{2} \qquad Eq . 24$$

and a square distance between a specific output color and the target color may be expressed as:

$${DE}_{0} = {( \frac{{dY}_{0}}{A} )}^{2} + {( \frac{{dU}_{0}}{B} )}^{2} + {( \frac{{dV}_{0}}{C} )}^{2} \qquad Eq . 25$$

and a ratio of the distance between the particular color and the target color and the distance between the specific output color and the target color may be expressed as:

$$r = \frac{DE}{{DE}_{0}} \qquad Eq . 26$$

The weighted interpolation function, in turn, may be expressed as follows:

$$dY = ( 1 - {r}^{k} ) {dY}_{0} \qquad Eq . 27$$

$$dU = ( 1 - {r}^{k} ) {dU}_{0} \qquad Eq . 28$$

$$dV = ( 1 - {r}^{k} ) {dV}_{0} \qquad Eq . 29$$

where k may be a strength of correction factor, which for example, may take a value of 2, 1, ½, ⅓, ¼, ⅕ or other value less than two, and the amount by which a particular color is to be adjusted with respect to each component value is (dY, dU, dV).

In applying one of the color mapping models described above, to correct or adjust the color of an input image, image processing logic 152 may examine each pixel of the input image to determine whether it falls within the ellipsoid region covered by the color mapping model. In some embodiments, this determination may be made by determining whether a distance (or square distance) between a particular pixel, (Yₚᵢₓ, Uₚᵢₓ, Vₚᵢₓ), and the target color of the color mapping model (e.g., determined using Equation 18 or Equation 24) is less than the distance (or square distance) between the specific output color of the color mapping model and the target color. That is, whether the following relationship is satisfied:

$$( DE < {DE}_{0} ) \qquad Eq . 30$$

If it does fall within the cuboid region, for example, if Equation 30 is satisfied, the image processing logic 152 may determine an amount of adjustment, for example, using Equations 21-23 or Equations 27-29, and may adjust the pixel value accordingly to obtain the output pixel:

$$( {Y}_{pix} + dY , {U}_{pix} + dU , {V}_{pix} + dV ) \qquad Eq . 31$$

In some embodiments, processing logic 150 may be used to provide a color mapping model definition tool that may be used to help define one or more color mapping models. In some embodiments, for example, the color mapping model definition tool may present a user interface to a user, for example, on a display of computing device 140 (not illustrated in FIG. 1), which the user may interact with to define different color mapping models. In some embodiments, for example, the color mapping model definition tool may allow a user to select (or otherwise specify) a target color within an input color space for adjustment. In some embodiments, for example, the color mapping model definition tool may present a user with an image captured from or by an image source, such as image capture device 110, which may be in an input color space (e.g., in a unique color space of image capture device 110). The color mapping model definition tool may allow the user to select a particular pixel within the input image (e.g., of an object captured in the input image) as a target color for adjustment. In some embodiments, the color mapping model definition tool may present a user with the input color space itself (e.g., a model or rendering of the input color space) and allow the user to select (or otherwise specify) a particular point in the input color space as a target color for adjustment. In some embodiments, the user may be able to select the target color by specifying corresponding color channel values (e.g., RGB or YUV values). In some embodiments, the color channel values may be pre-populated with values of a pixel or point selected by the user (e.g., from an input image or an input color space presented to the user through the color mapping model definition tool), which the user may then be able to adjust or overwrite.

Once the target color has been selected (or otherwise specified), the color mapping model definition tool may allow the user to select (or otherwise specify) an output color (in an output color space) to which the target color is to be mapped. In some embodiments, for example, where the target color was selected from an input image or color space presented to the user, the color mapping model definition tool may allow the user to select a different pixel or point within the input image or color space as the output color. In some embodiments, the color mapping model definition tool may allow the user to select a memory color associated with the selected target color (e.g., associated with the target color itself and/or an object in the input image comprising the pixel selected as the target color). The color mapping model definition tool, for example, may present the user with standardized pixel values associated with the selected target color (e.g., standardized pixel values for “stop light” or “stop sign” red) and allow the user to select a pixel value therefrom as the output color. In some embodiments, the user may be able to select the output color by specifying corresponding color channel values (e.g., RGB or YUV values). In some embodiments, the color channel values may be pre-populated with values of the target color selected by the user, which the user may then be able to adjust or overwrite.

In some embodiments, the color mapping model definition tool may also allow the user to select (or otherwise specify) neighboring colors in a localized region of the input color space to map to the output color space. In some embodiments, for example, the color mapping model definition tool may allow the user to specify a geometrically bounded region surrounding a target color that may be mapped to the output color space. In some embodiments, for example, a user may be able to select a type of geometry (e.g., a cuboid, ellipsoid, etc.) and specify different geometric parameters affecting a size and shape of the selected geometry. Illustratively, the color mapping model definition tool may allow a user to select (or otherwise specify) a pair of vertices in the input color space to define the boundary of a cuboid region centered about the target color. As another example, the color mapping model definition tool may allow a user to select (or otherwise specify) the radii and orientation angles of an ellipsoid region centered about the target color.

In some embodiments, the color mapping model definition tool may also allow the user to select (or otherwise specify) the mapping relationship used to map colors within the localized region geometrically bounded region to the output color space. In some embodiments, for example, the color mapping model definition tool may allow the user to select a mapping function from one or more different mapping functions. As an illustrative example, in some embodiments, the color mapping model definition tool may allow a user to select between different types of interpolative functions (e.g., linear interpolation functions, weighted interpolation functions, etc.). In some embodiments, the color mapping model definition tool may also allow the user to specify different mapping function parameters. By way of example, in some embodiments, the color mapping model definition tool may allow a user to select a type of distance measurement to be used by an interpolative function. In some embodiments, for example, where a weighted interpolation function is selected, the color mapping model definition tool may allow a user to specify a weighting function (e.g., spatial density function, such as a power function) to be used and/or one or more parameters thereof (e.g., a strength of correction factor of the power function).

In some embodiments, processing logic 150 may be used to optimize the parameters of a color mapping model (e.g., defined using a color mapping model definition tool, as described above) to obtain an optimized color mapping model. By way of example, a color mapping model may be defined to produce good color correction results for a particular image. A color mapping model, for instance, may be defined to adjust a color of an object that appears distorted in an input image to an associated memory color (e.g., as described above). The mapping relationship specified by the color mapping model, however, may produce undesirable contours (e.g., rapid color changes and/or color gaps or discontinuities) in the output color space. While the color mapping model may produce good color correction results for the particular input image, it may not perform well when applied to other images on account of such contours, for example, producing visible artifacts in color corrected versions of those images. In some embodiments, once a color mapping model is defined, it may be stored (e.g., in memory(ies) 144) as a color mapping model file 104. In some embodiments, the color mapping model file 104 may contain the various parameters that define the color mapping model, including for example, a target color in an input color space, a corresponding output color in an output color space (e.g., to which the target color is mapped), one or more geometric parameters (e.g., defining the localized region of neighboring colors that are to be adjusted), and/or one or more mapping function parameters (e.g., governing the mapping relationship of the color mapping model). In some embodiments, when performing a color correction process, one or more color mapping models may be retrieved and/or initialized by accessing and parsing corresponding color mapping model files 104.

In some embodiments, processing logic 150 may be used to perform an optimization process to adjust the parameters of a color mapping model to obtain an optimized color mapping model that minimizes the amount and/or degree of contours in the output color space and/or visible artifacts produced thereby. For example, as discussed above, a color mapping model may be parameterized by one or more parameters, including for example, a target color in an input color space, a corresponding output color in an output color space (e.g., to which the target color is mapped), one or more geometric parameters (e.g., defining the localized region of neighboring colors that are to be adjusted), and/or one or more mapping function parameters (e.g., governing the mapping relationship of the color mapping model). While these parameters may be manually adjusted, doing so can be a laborious process that may not result in an optimized color mapping model. Manual adjustment, for example, may involve applying the color mapping model to a set of sample images and adjusting different parameters of the color mapping model through repeated trial and error (e.g., based on whether the resulting color corrected image is visually appealing or not). Furthermore, because the process is subjective in nature and performed on a limited set of sample images (e.g., covering a limited set of use cases), the resulting color mapping model may be suboptimized.

In some embodiments, processing logic 150 may be used to perform an optimization process that is computationally driven, for example, based on different measurements or computed metrics. Furthermore, in some embodiments, the optimization process may use synthetically generated test images that may be specially constructed to help expose undesirable contours in the output color space and/or produce artifacts in resulting color adjusted images. In some embodiments, for example, an optimization process may involve applying a color mapping model to a synthetic test image. In some embodiments, for instance, a synthetic test image may be generated that includes a smooth color ramp (or color gradient), which for example, may span the gamut of colors in the localized subspace covered by the color mapping model. The color adjusted synthetic test image may undergo further processing to detect the presence of any artifacts produced therein.

In some embodiments, for example, the color adjusted synthetic test image may be subject to one or more processing operations, which may produce one or more metrics indicating the presence and/or absence of artifacts in the color adjusted image. In some embodiments, for example, the color adjusted test image may be passed through an edge detector (or be subject to an edge detection operation), which may produce different edge detection measurements or metrics (e.g., edge strength and/or gradient direction metrics). The resulting metrics may be compared to certain threshold criterion, based on which a determination may be made as to whether artifacts are present and/or absent from the color adjusted image. The threshold criterion, for example, may reflect a threshold of visibility (e.g., below which artifacts may not be visible). If one or more artifacts is detected, one or more model parameters may be adjusted, and the process may be repeated. This loop may continue until no visible artifacts are detected or further optimization is not possible. Once the optimization process is complete, the optimized color mapping model may be stored (e.g., as a color mapping model file 104 in memory(ies) 144).

In some embodiments, processing logic 150 may be used to perform an optimization process on a collection of color mapping models (e.g., defined using a color mapping model definition tool, as described above) to obtain an optimized collection of color mapping models. In some embodiments, for example, the optimization process may adjust the parameters of each color mapping model to obtain optimized color mapping models that minimize the amount and/or degree of contours in the output color space and/or visible artifacts collectively produced thereby. For example, in some cases, the effects of one color mapping model (in the collection of color mapping models) may impact whether undesirable contours and/or visible artifacts are produced by or result from another color mapping model (in the collection of color mapping models). While manual adjustment of a color mapping model may be possible, for example, using trial and error methods (as described above), manual adjustment of a collection of color mapping models may be even more involved with the results more likely to be suboptimized (for the reasons discussed above).

In some embodiments, an optimization process, similar to that described above with regard to a single color mapping model, may be performed across multiple color mapping models. In some embodiments, for example, an optimization process may involve applying a collection of color mapping models to one or more synthetic test images. The synthetic test images may be specially constructed to help expose undesirable contours in the resulting output color space and/or produce artifacts in the resulting color adjusted image. In some embodiments, for instance, synthetic test images may be generated that include smooth color ramps (or color gradients), which for example, may span a gamut of colors and collectively cover the target colors of each color mapping model in the collection. The color adjusted synthetic test images may undergo further processing to detect the presence of any artifacts produced therein. In some embodiments, for example, the color adjusted synthetic test images may be subject to one or more processing operations, which may produce one or more metrics indicating the presence and/or absence of artifacts in the color adjusted images. In some embodiments, for example, the color adjusted synthetic test images may be passed through an edge detector (or be subject to an edge detection operation), which may produce different edge detection measurements or metrics (e.g., edge strength and/or gradient direction metrics). The resulting metrics may be compared to certain threshold criterion (e.g., a threshold of visibility), based on which a determination may be made as to whether artifacts are present and/or absent in a color adjusted image. The threshold criterion, for example, may reflect a threshold of visibility (e.g., below which artifacts may not be visible). If one or more artifacts is detected, one or more parameters of one or more color mapping models may be adjusted, and the process may be repeated. This loop may continue until no visible artifacts are detected or further optimization is not possible. Once the optimization process is complete, the optimized color mapping models may be stored (e.g., as one or more color mapping model file(s) 104 in memory(ies) 144). The optimization processes disclosed herein may greatly reduce the time and effort spent on developing color mapping model(s), for example, as compared to manual approaches (e.g., involving trial and error). Furthermore, because the optimization processes are metric driven, using specially constructed synthetic test images, they may produce superior results, for example, as compared to manual approaches.

It will be appreciated that the embodiments illustrated in FIG. 1 and described above are merely illustrative and that those of skill in the art will understand and appreciate that additional and alternative embodiments are possible. For example, while illustrated and described as separate components, in some embodiments, the image capture device 110 and computing device 140 may be combined. As another example, in some embodiments, processor(s) 112 may include at least a portion of the processing logic 150 of processor(s) 152 and may be configured to perform the functionality described herein with respect thereto. In some embodiments, for instance, processing logic 120 of processor(s) 112 may be used to perform one or more color correction (or color adjustment) processes. In at least one embodiment, for example, image processing logic 122 may be used to perform an initial color correction process to perform color correction to adjust the colors of images to produce a more color-accurate representation of a scenes captured therein. In some embodiments, for example, image processing logic 122 may be used to adjust the colors of images to account for the unique properties of image capture device 110 and its sensor(s) 115. In some embodiments, for example, image processing logic 122 may be used to perform color correction to adjust the colors of a captured image to match a standardized color space like CIELAB or CIELUV, which may allow for a more faithful color rendition of the captured image when reproduced (e.g., displayed). In some embodiments, for example, the image capture device 110 may employ a CCM or LUT-based approach to perform the initial color correction process (e.g., as described above with respect to computing device 140). In some embodiments, the color corrected images may be provided to computing device 140, which may further process the images. In some embodiments, for example, computing device 140 may be used to perform one or more additional color correction processes (e.g., using image processing logic 152 of processor(s) 142 thereof, as described above).

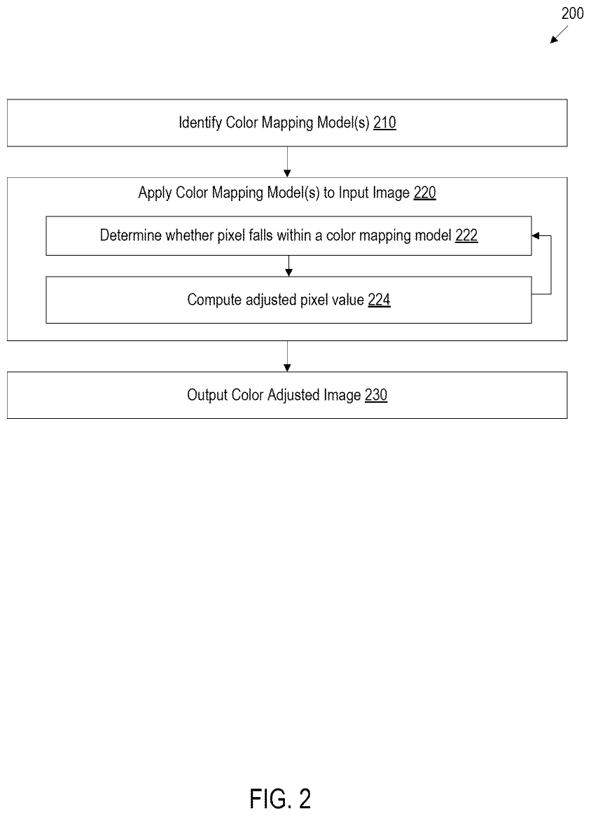

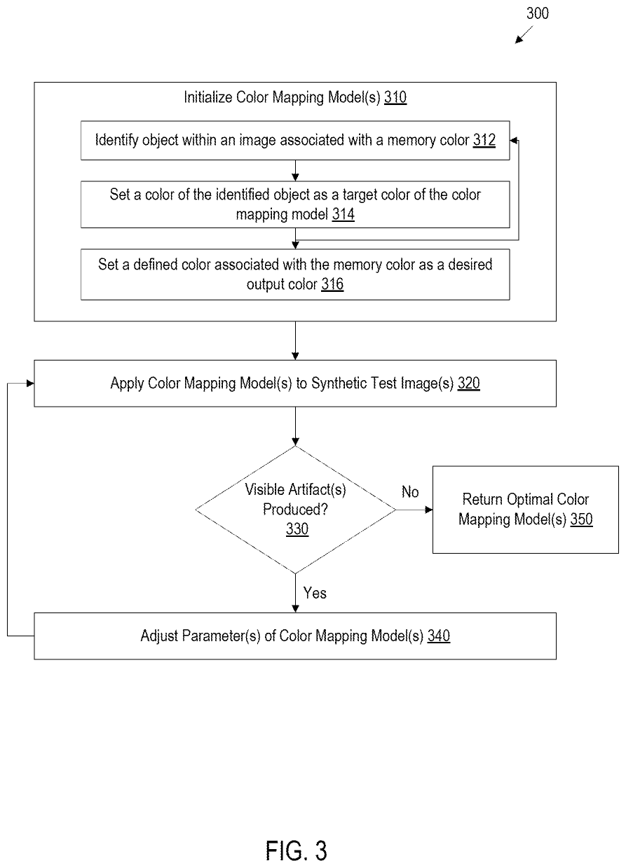

FIGS. 2-3 illustrate example methods in accordance with embodiments of the present disclosure. For the sake of simplicity and clarity, these methods are depicted and described as a series of operations. However, in accordance with the present disclosure, such operations may be performed in other orders and/or concurrently, and with other operations not presented or described herein. Furthermore, not all illustrated operations may be required in implementing methods in accordance with the present disclosure. Those of skill in the art will also understand and appreciate that the methods could be represented as a series of interrelated states or events via a state diagram. Additionally, it will be appreciated that the disclosed methods are capable of being stored on an article of manufacture. The term “article of manufacture,” as used herein, is intended to encompass a computer-readable device or storage media provided with a computer program and/or executable instructions that, when executed, affect one or more operations.

FIG. 2 illustrates a flow diagram of an example method 200 for performing a color correction process using one or more color mapping models. The method 200 may be performed by processing logic of a computing device (e.g., using processor(s) 142 of computing device 140 shown in FIG. 1).

At operation 210, the processing logic may identify one or more color mapping models that are to be applied to an input image as part of a color correction process. In some embodiments, for example, color mapping models may be used to provide for color adjustment (or warping) of specific colors within an input color space. In some embodiments, for example, one or more color mapping models may be defined for localized regions of an input color space (or localized subspaces). In some embodiments, the color mapping models may specify a mapping relationship or function (e.g., a mathematical relationship or function) between input colors (e.g., input pixel values or components thereof) within the localized subspaces and output colors (e.g., output pixel values or components thereof) in an output color space. In some embodiments, for example, color mapping models may be defined that map particular target colors in an input color space to specific output colors in an output color space. In some embodiments, the color mapping models may also map neighboring colors in the input color space, for example, in a localized region (or subspace) surrounding a target color (e.g., covering similar shades of red or green), to the output color space. In some embodiments, for example, the color mapping models may map colors that fall within a geometrically bounded region surrounding the target color (e.g., within a cuboid or ellipsoid centered about the target color) to the output color space. The contours of the bounded region may be provided by one or more geometric parameters, which for example, may affect a size, shape, and orientation of the region (e.g., in the input color space). In some embodiments, the mapping relationship specified by a color mapping model may provide for a smooth overall color adjustment. In some embodiments, for example, the mapping relationship specified by the color mapping models may transition from maximal adjustment of the target color (e.g., to the specific output color) to minimal adjustment (e.g., no adjustment) of colors falling along the boundary of the color mapping model (e.g., of the localized region covered by the color mapping model). In some embodiments, for example, the color mapping model may define an interpolative function that can be used to determine an amount of adjustment for colors falling there between (e.g., between the target color and model boundary).

At operation 220, the processing logic may apply the identified color mapping models to the input image. In some embodiments, at block 222, the processing logic may examine each pixel of the input image to determine whether it falls within a localized region of one of the color mapping models being applied. If a pixel does fall within a color mapping model, the pixel value may be adjusted according to the mathematical relationship specified by the color mapping model in which it falls. In some embodiments, for example, at block 224, an amount of adjustment may be determined (e.g., with respect to each component value of the pixel), and an adjusted pixel value may be computed (e.g., by affecting the determined adjustment). Alternatively, if a pixel does not fall within any color mapping model, the pixel value may remain unchanged. After each pixel of the image has been processed at operation 220, the color adjusted image may be output at operation 230.

FIG. 3 illustrates a flow diagram of an example method for optimizing one or more color mapping models. The method 300 may be performed by processing logic of a computing device (e.g., using processor(s) 142 of computing device 140 shown in FIG. 1).

At operation 310, the processing logic may initialize one or more color mapping model(s). In some embodiments, for example, the processing logic may access and parse one or more color mapping model file(s) to obtain parameters for the one or more color mapping model(s). The processing logic may use these parameters to initialize the color mapping model(s). In some embodiments, the processing logic may provide a color mapping model definition tool that may be used to help define and initialize one or more color mapping model(s). In some embodiments, for example, the color mapping model definition tool may present a user interface to a user, with which the user may interact to define different color mapping models. In some embodiments, for example, the color mapping model definition tool may allow a user to select (or otherwise specify) a target color within an input color space for adjustment. In some embodiments, for example, the color mapping model definition tool may present a user with an image captured from or by an image source, which may be in an input color space (e.g., in a unique color space of the image source). In some embodiments, at block 312, the color mapping model definition tool may allow the user to select a particular pixel of an object captured in the input image. In some embodiments, at block 314, the selected pixel may be set as the target color of a color mapping model.

Once the target color has been selected (or otherwise specified), at block 316, the color mapping model definition tool may allow the user to select (or otherwise specify) an output color (in an output color space) to which the target color is to be mapped. In some embodiments, for example, where the target color was selected from an input image or color space presented to the user, the color mapping model definition tool may allow the user to select a different pixel or point within the input image or color space as the output color. In some embodiments, the color mapping model definition tool may allow the user to select a memory color associated with the selected target color (e.g., associated with the target color itself and/or an object in the input image comprising the pixel selected as the target color). The color mapping model definition tool, for example, may present the user with standardized pixel values associated with the selected target color (e.g., standardized pixel values for “stop light” or “stop sign” red) and allow the user to select a pixel value therefrom as the output color. In some embodiments, the user may be able to select the output color by specifying corresponding color channel values (e.g., RGB or YUVvalues). In some embodiments, the color channel values may be pre-populated with values of the target color selected by the user, which the user may then be able to adjust or overwrite.

In some embodiments, the color mapping model definition tool may also allow the user to select (or otherwise specify) neighboring colors in a localized region of the input color space to map to the output color space. In some embodiments, for example, the color mapping model definition tool may allow the user to specify a geometrically bounded region surrounding a target color that may be mapped to the output color space. In some embodiments, for example, a user may be able to select a type of geometry (e.g., a cuboid, ellipsoid, etc.) and specify different geometric parameters affecting a size and shape of the selected geometry. Illustratively, the color mapping model definition tool may allow a user to select (or otherwise specify) a pair of vertices in the input color space to define the boundary of a cuboid region centered about the target color. As another example, the color mapping model definition tool may allow a user to select (or otherwise specify) the radii and orientation angles of an ellipsoid region centered about the target color.

In some embodiments, the color mapping model definition tool may also allow the user to select (or otherwise specify) the mapping relationship used to map colors within the localized region geometrically bounded region to the output color space. In some embodiments, for example, the color mapping model definition tool may allow the user to select a mapping function from one or more different mapping functions. As an illustrative example, in some embodiments, the color mapping model definition tool may allow a user to select between different types of interpolative functions (e.g., linear interpolation functions, weighted interpolation functions, etc.). In some embodiments, the color mapping model definition tool may also allow the user to specify different mapping function parameters. By way of example, in some embodiments, the color mapping model definition tool may allow a user to select a type of distance measurement to be used by an interpolative function. In some embodiments, for example, where a weighted interpolation function is selected, the color mapping model definition tool may allow a user to specify a weighting function (e.g., spatial density function, such as a power function) to be used and/or one or more parameters thereof (e.g., a strength of correction factor of the power function). In some embodiments, once the color mapping model has been defined, the process may be repeated to define another color mapping model. In some embodiments, this may repeat until all desired color mapping models have been defined, for example, until color mapping models have been defined for all relevant target colors (e.g., relevant to a particular use case or application).

In some embodiments, the processing logic may perform an optimization process to optimize a particular color model initialized at operation 310. In some embodiments, for example, an optimization process may be performed to adjust the parameters of a particular color mapping model to obtain an optimized color mapping model that minimizes the amount and/or degree of contours in the output color space and/or visible artifacts produced thereby. In some embodiments, for example, at operation 320, the processing logic may apply the particular color mapping model to a synthetic test image. In some embodiments, the synthetic test image may be generated to include a smooth color ramp (or color gradient) that spans the gamut of colors in the localized subspace covered by the particular color mapping model. In some embodiments, at operation 330, the color adjusted synthetic test image may be subject to one or more processing operations, which may produce one or more metrics indicating the presence and/or absence of artifacts in the color adjusted image. In some embodiments, for example, the color adjusted test image may be passed through an edge detector (or be subject to an edge detection operation), which may produce different edge detection measurements or metrics (e.g., edge strength and/or gradient direction metrics). The resulting metrics may be compared to certain threshold criterion, based on which a determination may be made as to whether artifacts are present and/or absent from the color adjusted image. The threshold criterion, for example, may reflect a threshold of visibility (e.g., below which artifacts may not be visible). If one or more artifacts is detected, at operation 340, one or more model parameters may be adjusted, and the method 300 may return to operation 320. This loop may continue until no visible artifacts are detected or further optimization is not possible. Once the optimization process is complete, at operation 350, the processing logic may return the optimized color mapping model, which may be stored for later use.

In some embodiments, processing logic may perform a similar optimization process to optimize the collection of color mapping models initialized at operation 310 to obtain an optimized collection of color mapping models. In some embodiments, for example, an optimization process may be performed to adjust the parameters of each color mapping model to obtain optimized color mapping models that minimize the amount and/or degree of contours in the output color space and/or visible artifacts collectively produced thereby.

In some embodiments, for example, at operation 320, processing logic may apply the collection of color mapping models to one or more synthetic test images. The synthetic test images may be specially constructed to help expose undesirable contours in the resulting output color space and/or produce artifacts in the resulting color adjusted image. In some embodiments, for instance, synthetic test images may be generated that include smooth color ramps (or color gradients) that span a gamut of colors and collectively cover the target colors of each color mapping model in the collection. In some embodiments, at operation 330, the color adjusted synthetic test images may be subject to one or more processing operations, which may produce one or more metrics indicating the presence and/or absence of artifacts in the color adjusted synthetic images. In some embodiments, for example, the color adjusted test images may be passed through an edge detector (or be subject to an edge detection operation), which may produce different edge detection measurements or metrics (e.g., edge strength and/or gradient direction metrics). The resulting metrics may be compared to certain threshold criterion (e.g., a threshold of visibility), based on which a determination may be made as to whether artifacts are present and/or absent in a color adjusted image. The threshold criterion, for example, may reflect a threshold of visibility (e.g., below which artifacts may not be visible). If one or more artifacts is detected, at operation 340, one or more parameters of one or more color mapping models in the collection of color mapping models may be adjusted, and the method 300 may return to operation 320. This loop may continue until no visible artifacts are detected or further optimization is not possible. Once the optimization process is complete, at operation 350, the processing logic may return the collection of optimized color mapping models, which may be stored for later use.

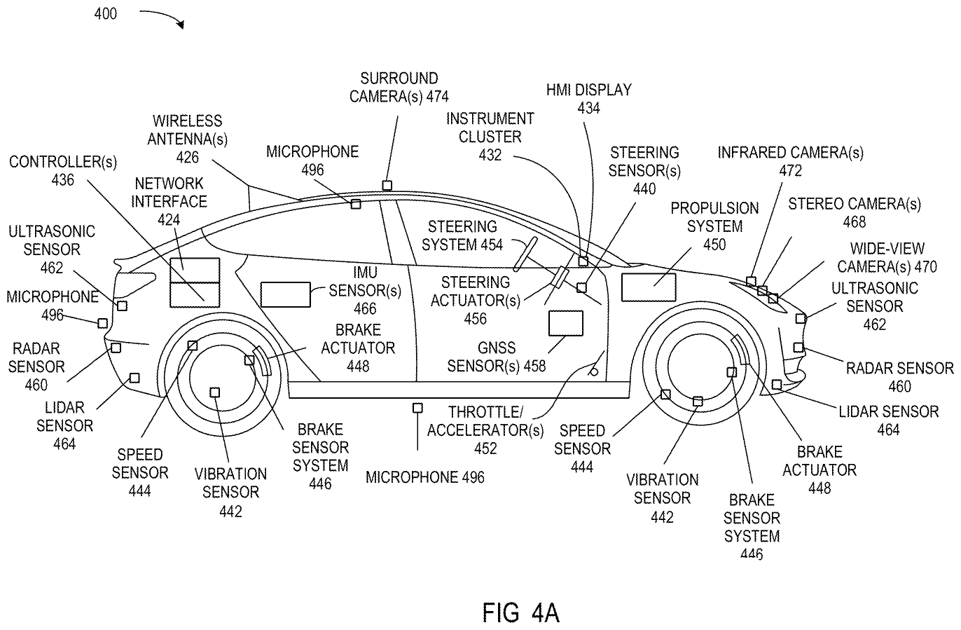

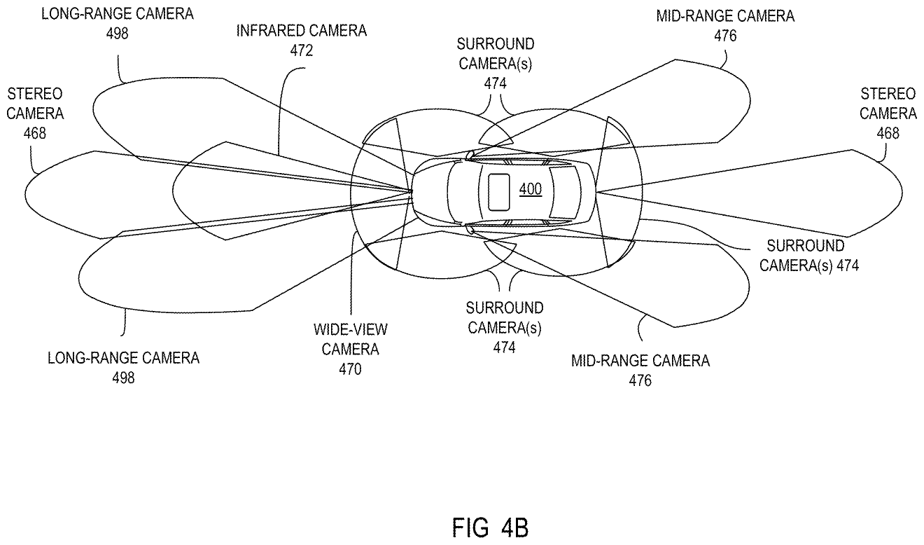

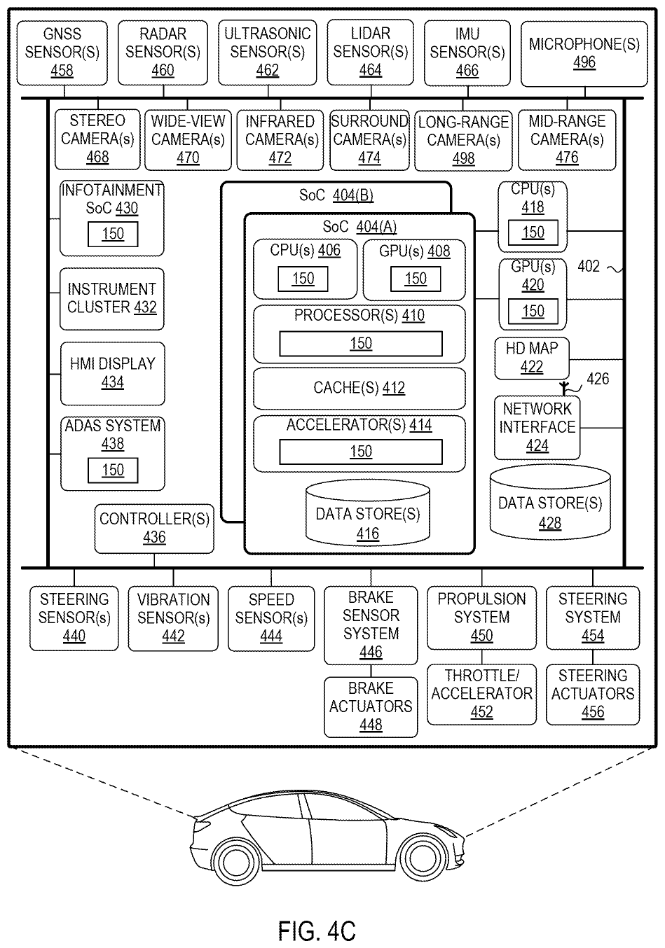

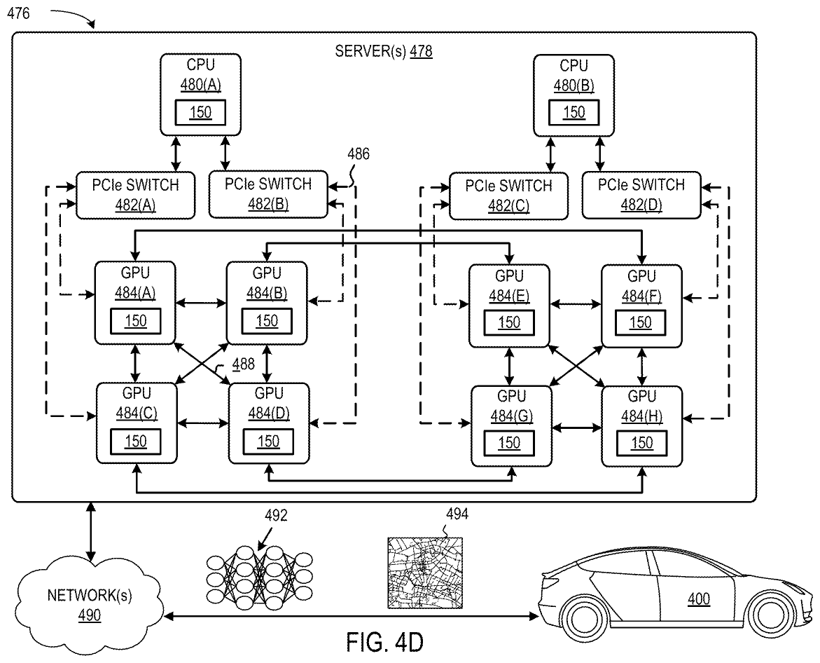

FIG. 4A illustrates an example of an autonomous vehicle 400, according to at least one embodiment. In at least one embodiment, autonomous vehicle 400 (alternatively referred to herein as “vehicle 400”) may be, without limitation, a passenger vehicle, such as a car, a truck, a bus, and/or another type of vehicle that accommodates one or more passengers. In at least one embodiment, vehicle 400 may be a semi-tractor-trailer truck used for hauling cargo. In at least one embodiment, vehicle 400 may be an airplane, robotic vehicle, or other kind of vehicle.

Autonomous vehicles may be described in terms of automation levels, defined by National Highway Traffic Safety Administration (“NHTSA”), a division of US Department of Transportation, and Society of Automotive Engineers (“SAE”) “Taxonomy and Definitions for Terms Related to Driving Automation Systems for On-Road Motor Vehicles” (e.g., Standard No. J3016-201806, published on Jun. 15, 2018, Standard No. J3016-201409, published on Sep. 30, 2016, and previous and future versions of this standard). In at least one embodiment, vehicle 400 may be capable of functionality in accordance with one or more of Level 1 through Level 5 of autonomous driving levels. For example, in at least one embodiment, vehicle 400 may be capable of conditional automation (Level 3), high automation (Level 4), and/or full automation (Level 5), depending on embodiment.

In at least one embodiment, vehicle 400 may include, without limitation, components such as a chassis, a vehicle body, wheels (e.g., 2, 4, 6, 8, 18, etc.), tires, axles, and other components of a vehicle. In at least one embodiment, vehicle 400 may include, without limitation, a propulsion system 450, such as an internal combustion engine, hybrid electric power plant, an all-electric engine, and/or another propulsion system type. In at least one embodiment, propulsion system 450 may be connected to a drive train of vehicle 400, which may include, without limitation, a transmission, to enable propulsion of vehicle 400. In at least one embodiment, propulsion system 450 may be controlled in response to receiving signals from a throttle/accelerator(s) 452.

In at least one embodiment, a steering system 454, which may include, without limitation, a steering wheel, is used to steer vehicle 400 (e.g., along a desired path or route) when propulsion system 450 is operating (e.g., when vehicle 400 is in motion). In at least one embodiment, steering system 454 may receive signals from steering actuator(s) 456. In at least one embodiment, a steering wheel may be optional for full automation (Level 5) functionality. In at least one embodiment, a brake sensor system 446 may be used to operate vehicle brakes in response to receiving signals from brake actuator(s) 448 and/or brake sensors.

In at least one embodiment, controller(s) 436, which may include, without limitation, one or more system on chips (“SoCs”) (not shown in FIG. 4A) and/or graphics processing unit(s) (“GPU(s)”), provide signals (e.g., representative of commands) to one or more components and/or systems of vehicle 400. For instance, in at least one embodiment, controller(s) 436 may send signals to operate vehicle brakes via brake actuator(s) 448, to operate steering system 454 via steering actuator(s) 456, to operate propulsion system 450 via throttle/accelerator(s) 452. In at least one embodiment, controller(s) 436 may include one or more onboard (e.g., integrated) computing devices that process sensor signals, and output operation commands (e.g., signals representing commands) to enable autonomous driving and/or to assist a human driver in driving vehicle 400. In at least one embodiment, controller(s) 436 may include a first controller for autonomous driving functions, a second controller for functional safety functions, a third controller for artificial intelligence functionality (e.g., computer vision), a fourth controller for infotainment functionality, a fifth controller for redundancy in emergency conditions, and/or other controllers. In at least one embodiment, a single controller may handle two or more of above functionalities, two or more controllers may handle a single functionality, and/or any combination thereof.

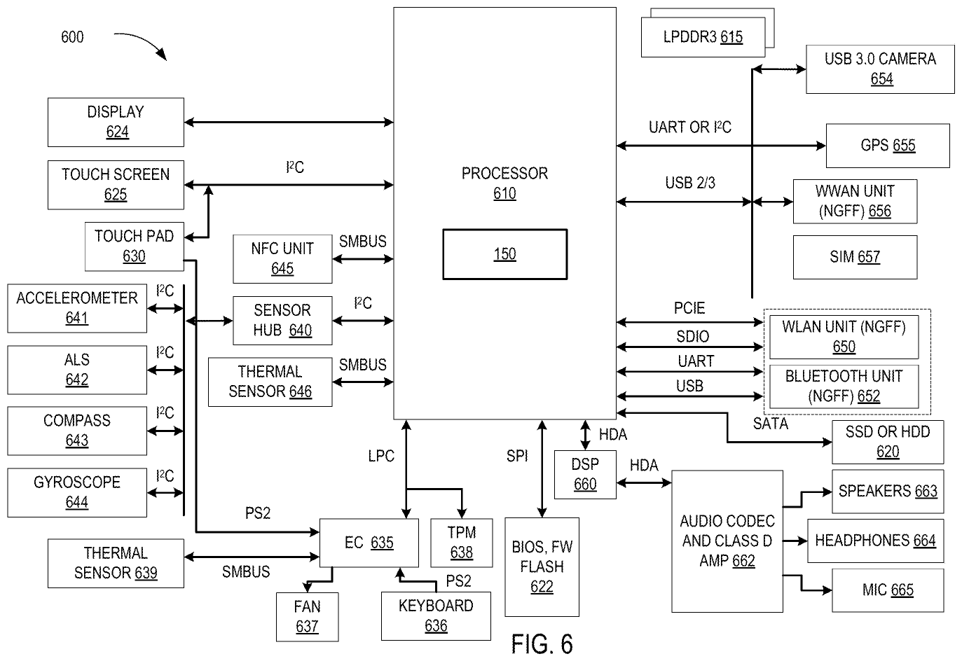

In at least one embodiment, controller(s) 436 provide signals for controlling one or more components and/or systems of vehicle 400 in response to sensor data received from one or more sensors (e.g., sensor inputs). In at least one embodiment, sensor data may be received from, for example and without limitation, global navigation satellite systems (“GNSS”) sensor(s) 458 (e.g., Global Positioning System sensor(s)), RADAR sensor(s) 460, ultrasonic sensor(s) 462, LIDAR sensor(s) 464, inertial measurement unit (“IMU”) sensor(s) 466 (e.g., accelerometer(s), gyroscope(s), a magnetic compass or magnetic compasses, magnetometer(s), etc.), microphone(s) 496, stereo camera(s) 468, wide-view camera(s) 470 (e.g., fisheye cameras), infrared camera(s) 472, surround camera(s) 474 (e.g., 360 degree cameras), long-range cameras (not shown in FIG. 6A), mid-range camera(s) (not shown in FIG. 6A), speed sensor(s) 444 (e.g., for measuring speed of vehicle 400), vibration sensor(s) 442, steering sensor(s) 440, brake sensor(s) (e.g., as part of brake sensor system 446), and/or other sensor types.

In at least one embodiment, one or more of controller(s) 436 may receive inputs (e.g., represented by input data) from an instrument cluster 432 of vehicle 400 and provide outputs (e.g., represented by output data, display data, etc.) via a human-machine interface (“HMI”) display 434, an audible annunciator, a loudspeaker, and/or via other components of vehicle 400. In at least one embodiment, outputs may include information such as vehicle velocity, speed, time, map data (e.g., a High Definition map (not shown in FIG. 4A), location data (e.g., vehicle's 400 location, such as on a map), direction, location of other vehicles (e.g., an occupancy grid), information about objects and status of objects as perceived by controller(s) 436, etc. For example, in at least one embodiment, HMI display 434 may display information about presence of one or more objects (e.g., a street sign, caution sign, traffic light changing, etc.), and/or information about driving maneuvers vehicle has made, is making, or will make (e.g., changing lanes now, taking exit 34B in two miles, etc.).

In at least one embodiment, vehicle 400 further includes a network interface 424 which may use wireless antenna(s) 426 and/or modem(s) to communicate over one or more networks. For example, in at least one embodiment, network interface 424 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”) networks, etc. In at least one embodiment, wireless antenna(s) 426 may also enable communication between objects in environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc. protocols.

Processing logic 150 may be used to perform image processing operations, including color correction operations, associated with one or more embodiments. Details regarding processing logic 150 are provided herein in conjunction with FIG. 1. In at least one embodiment, processing logic 150 may be used in the autonomous vehicle 400 of FIG. 4A for performing image processing operations, including color correction operations.

FIG. 4B illustrates an example of camera locations and fields of view for autonomous vehicle 400 of FIG. 4A, according to at least one embodiment. In at least one embodiment, cameras and respective fields of view are one example embodiment and are not intended to be limiting. For instance, in at least one embodiment, additional and/or alternative cameras may be included and/or cameras may be located at different locations on vehicle 400.

In at least one embodiment, camera types for cameras may include, but are not limited to, digital cameras that may be adapted for use with components and/or systems of vehicle 400. In at least one embodiment, camera(s) may operate at automotive safety integrity level (“ASIL”) B and/or at another ASIL. In at least one embodiment, camera types may be capable of any image capture rate, such as 60 frames per second (fps), 1220 fps, 240 fps, etc., depending on embodiment. In at least one embodiment, cameras may be capable of using rolling shutters, global shutters, another type of shutter, or a combination thereof. In at least one embodiment, color filter array may include a red clear clear clear (“RCCC”) color filter array, a red clear clear blue (“RCCB”) color filter array, a red blue green clear (“RBGC”) color filter array, a Foveon X3 color filter array, a Bayer sensors (“RGGB”) color filter array, a monochrome sensor color filter array, and/or another type of color filter array. In at least one embodiment, clear pixel cameras, such as cameras with an RCCC, an RCCB, and/or an RBGC color filter array, may be used in an effort to increase light sensitivity.

In at least one embodiment, one or more of camera(s) may be used to perform advanced driver assistance systems (“ADAS”) functions (e.g., as part of a redundant or fail-safe design). For example, in at least one embodiment, a Multi-Function Mono Camera may be installed to provide functions including lane departure warning, traffic sign assist and intelligent headlamp control. In at least one embodiment, one or more of camera(s) (e.g., all cameras) may record and provide image data (e.g., video) simultaneously.

In at least one embodiment, one or more cameras may be mounted in a mounting assembly, such as a custom designed (three-dimensional (“3D”) printed) assembly, in order to cut out stray light and reflections from within vehicle 400 (e.g., reflections from dashboard reflected in windshield mirrors) which may interfere with camera image data capture abilities. With reference to wing-mirror mounting assemblies, in at least one embodiment, wing-mirror assemblies may be custom 3D printed so that a camera mounting plate matches a shape of a wing-mirror. In at least one embodiment, camera(s) may be integrated into wing-mirrors. In at least one embodiment, for side-view cameras, camera(s) may also be integrated within four pillars at each corner of a cabin.

In at least one embodiment, cameras with a field of view that include portions of an environment in front of vehicle 400 (e.g., front-facing cameras) may be used for surround view, to help identify forward facing paths and obstacles, as well as aid in, with help of one or more of controller(s) 436 and/or control SoCs, providing information critical to generating an occupancy grid and/or determining preferred vehicle paths. In at least one embodiment, front-facing cameras may be used to perform many similar ADAS functions as LIDAR, including, without limitation, emergency braking, pedestrian detection, and collision avoidance. In at least one embodiment, front-facing cameras may also be used for ADAS functions and systems including, without limitation, Lane Departure Warnings (“LDW”), Autonomous Cruise Control (“ACC”), and/or other functions such as traffic sign recognition.

In at least one embodiment, a variety of cameras may be used in a front-facing configuration, including, for example, a monocular camera platform that includes a CMOS (“complementary metal oxide semiconductor”) color imager. In at least one embodiment, a wide-view camera 470 may be used to perceive objects coming into view from a periphery (e.g., pedestrians, crossing traffic or bicycles). Although only one wide-view camera 470 is illustrated in FIG. 4B, in other embodiments, there may be any number (including zero) wide-view cameras on vehicle 400. In at least one embodiment, any number of long-range camera(s) 498 (e.g., a long-view stereo camera pair) may be used for depth-based object detection, especially for objects for which a neural network has not yet been trained. In at least one embodiment, long-range camera(s) 498 may also be used for object detection and classification, as well as basic object tracking.

In at least one embodiment, any number of stereo camera(s) 468 may also be included in a front-facing configuration. In at least one embodiment, one or more of stereo camera(s) 468 may include an integrated control unit comprising a scalable processing unit, which may provide a programmable logic (“FPGA”) and a multi-core micro-processor with an integrated Controller Area Network (“CAN”) or Ethernet interface on a single chip. In at least one embodiment, such a unit may be used to generate a 3D map of an environment of vehicle 400, including a distance estimate for all points in an image. In at least one embodiment, one or more of stereo camera(s) 468 may include, without limitation, compact stereo vision sensor(s) that may include, without limitation, two camera lenses (one each on left and right) and an image processing chip that may measure distance from vehicle 400 to target object and use generated information (e.g., metadata) to activate autonomous emergency braking and lane departure warning functions. In at least one embodiment, other types of stereo camera(s) 468 may be used in addition to, or alternatively from, those described herein.

In at least one embodiment, cameras with a field of view that include portions of environment to sides of vehicle 400 (e.g., side-view cameras) may be used for surround view, providing information used to create and update an occupancy grid, as well as to generate side impact collision warnings. For example, in at least one embodiment, surround camera(s) 474 (e.g., four surround cameras as illustrated in FIG. 4B) could be positioned on vehicle 400. In at least one embodiment, surround camera(s) 474 may include, without limitation, any number and combination of wide-view cameras, fisheye camera(s), 360-degree camera(s), and/or similar cameras. For instance, in at least one embodiment, four fisheye cameras may be positioned on a front, a rear, and sides of vehicle 400. In at least one embodiment, vehicle 400 may use three surround camera(s) 474 (e.g., left, right, and rear), and may leverage one or more other camera(s) (e.g., a forward-facing camera) as a fourth surround-view camera.

In at least one embodiment, cameras with a field of view that include portions of an environment behind vehicle 400 (e.g., rear-view cameras) may be used for parking assistance, surround view, rear collision warnings, and creating and updating an occupancy grid. In at least one embodiment, a wide variety of cameras may be used including, but not limited to, cameras that are also suitable as a front-facing camera(s) (e.g., long-range cameras 498 and/or mid-range camera(s) 476, stereo camera(s) 468), infrared camera(s) 472, etc.), as described herein.

Processing logic 150 may be used to perform image processing operations, including color correction operations, associated with one or more embodiments. Details regarding processing logic 150 are provided herein in conjunction with FIG. 1. In at least one embodiment, processing logic 150 may be used in the autonomous vehicle 400 of FIG. 4B for performing image processing operations, including color correction operations.

FIG. 4C is a block diagram illustrating an example system architecture for autonomous vehicle 400 of FIG. 4A, according to at least one embodiment. In at least one embodiment, each of components, features, and systems of vehicle 400 in FIG. 4C is illustrated as being connected via a bus 402. In at least one embodiment, bus 402 may include, without limitation, a CAN data interface (alternatively referred to herein as a “CAN bus”). In at least one embodiment, a CAN may be a network inside vehicle 400 used to aid in control of various features and functionality of vehicle 400, such as actuation of brakes, acceleration, braking, steering, windshield wipers, etc. In at least one embodiment, bus 402 may be configured to have dozens or even hundreds of nodes, each with its own unique identifier (e.g., a CAN ID). In at least one embodiment, bus 402 may be read to find steering wheel angle, ground speed, engine revolutions per minute (“RPMs”), button positions, and/or other vehicle status indicators. In at least one embodiment, bus 402 may be a CAN bus that is ASIL B compliant.

In at least one embodiment, in addition to, or alternatively from CAN, FlexRay and/or Ethernet protocols may be used. In at least one embodiment, there may be any number of busses forming bus 402, which may include, without limitation, zero or more CAN busses, zero or more FlexRay busses, zero or more Ethernet busses, and/or zero or more other types of busses using different protocols. In at least one embodiment, two or more busses may be used to perform different functions, and/or may be used for redundancy. For example, a first bus may be used for collision avoidance functionality and a second bus may be used for actuation control. In at least one embodiment, each bus of bus 402 may communicate with any of components of vehicle 400, and two or more busses of bus 402 may communicate with corresponding components. In at least one embodiment, each of any number of system(s) on chip(s) (“SoC(s)”) 404 (such as SoC 404(A) and SoC 404(B), each of controller(s) 436, and/or each computer within vehicle may have access to same input data (e.g., inputs from sensors of vehicle 400), and may be connected to a common bus, such CAN bus.

In at least one embodiment, vehicle 400 may include one or more controller(s) 436, such as those described herein with respect to FIG. 4A. In at least one embodiment, controller(s) 436 may be used for a variety of functions. In at least one embodiment, controller(s) 436 may be coupled to any of various other components and systems of vehicle 400, and may be used for control of vehicle 400, artificial intelligence of vehicle 400, infotainment for vehicle 400, and/or other functions.

In at least one embodiment, vehicle 400 may include any number of SoCs 404. In at least one embodiment, each of SoCs 404 may include, without limitation, central processing units (“CPU(s)”) 406, graphics processing units (“GPU(s)”) 408, processor(s) 410, cache(s) 412, accelerator(s) 414, data store(s) 416, and/or other components and features not illustrated. In at least one embodiment, SoC(s) 404 may be used to control vehicle 400 in a variety of platforms and systems. For example, in at least one embodiment, SoC(s) 404 may be combined in a system (e.g., system of vehicle 400) with a High Definition (“HD”) map 422 which may obtain map refreshes and/or updates via network interface 424 from one or more servers (not shown in FIG. 6C).

In at least one embodiment, CPU(s) 406 may include a CPU cluster or CPU complex (alternatively referred to herein as a “CCPLEX”). In at least one embodiment, CPU(s) 406 may include multiple cores and/or level two (“L2”) caches. For instance, in at least one embodiment, CPU(s) 406 may include eight cores in a coherent multi-processor configuration. In at least one embodiment, CPU(s) 406 may include four dual-core clusters where each cluster has a dedicated L2 cache (e.g., a 2 megabyte (MB) L2 cache). In at least one embodiment, CPU(s) 406 (e.g., CCPLEX) may be configured to support simultaneous cluster operations enabling any combination of clusters of CPU(s) 406 to be active at any given time.

In at least one embodiment, one or more of CPU(s) 406 may implement power management capabilities that include, without limitation, one or more of following features: individual hardware blocks may be clock-gated automatically when idle to save dynamic power; each core clock may be gated when such core is not actively executing instructions due to execution of Wait for Interrupt (“WFI”)/Wait for Event (“WFE”) instructions; each core may be independently power-gated; each core cluster may be independently clock-gated when all cores are clock-gated or power-gated; and/or each core cluster may be independently power-gated when all cores are power-gated. In at least one embodiment, CPU(s) 406 may further implement an enhanced algorithm for managing power states, where allowed power states and expected wakeup times are specified, and hardware/microcode determines which best power state to enter for core, cluster, and CCPLEX. In at least one embodiment, processing cores may support simplified power state entry sequences in software with work offloaded to microcode.

In at least one embodiment, GPU(s) 408 may include an integrated GPU (alternatively referred to herein as an “iGPU”). In at least one embodiment, GPU(s) 408 may be programmable and may be efficient for parallel workloads. In at least one embodiment, GPU(s) 408 may use an enhanced tensor instruction set. In at least one embodiment, GPU(s) 408 may include one or more streaming microprocessors, where each streaming microprocessor may include a level one (“L1”) cache (e.g., an L1 cache with at least 96 KB storage capacity), and two or more streaming microprocessors may share an L2 cache (e.g., an L2 cache with a 512 KB storage capacity). In at least one embodiment, GPU(s) 408 may include at least eight streaming microprocessors. In at least one embodiment, GPU(s) 408 may use compute application programming interface(s) (API(s)). In at least one embodiment, GPU(s) 408 may use one or more parallel computing platforms and/or programming models (e.g., NVIDIA's CUDA model).

In at least one embodiment, one or more of GPU(s) 408 may be power-optimized for best performance in automotive and embedded use cases. For example, in at least one embodiment, GPU(s) 408 could be fabricated on Fin field-effect transistor (“FinFET”) circuitry. In at least one embodiment, each streaming microprocessor may incorporate a number of mixed-precision processing cores partitioned into multiple blocks. For example, and without limitation, 64 PF32 cores and 32 PF64 cores could be partitioned into four processing blocks. In at least one embodiment, each processing block could be allocated 16 FP32 cores, 8 FP64 cores, 16 INT32 cores, two mixed-precision NVIDIA Tensor cores for deep learning matrix arithmetic, a level zero (“L0”) instruction cache, a warp scheduler, a dispatch unit, and/or a 64 KB register file. In at least one embodiment, streaming microprocessors may include independent parallel integer and floating-point data paths to provide for efficient execution of workloads with a mix of computation and addressing calculations. In at least one embodiment, streaming microprocessors may include independent thread scheduling capability to enable finer-grain synchronization and cooperation between parallel threads. In at least one embodiment, streaming microprocessors may include a combined L1 data cache and shared memory unit in order to improve performance while simplifying programming.

In at least one embodiment, one or more of GPU(s) 408 may include a high bandwidth memory (“HBM) and/or a 16 GB HBM2 memory subsystem to provide, in some examples, about 900 GB/second peak memory bandwidth. In at least one embodiment, in addition to, or alternatively from, HBM memory, a synchronous graphics random-access memory (“SGRAM”) may be used, such as a graphics double data rate type five synchronous random-access memory (“GDDR5”).

In at least one embodiment, GPU(s) 408 may include unified memory technology. In at least one embodiment, address translation services (“ATS”) support may be used to allow GPU(s) 408 to access CPU(s) 406 page tables directly. In at least one embodiment, embodiment, when a GPU of GPU(s) 408 memory management unit (“MMU”) experiences a miss, an address translation request may be transmitted to CPU(s) 406. In response, 2 CPU of CPU(s) 406 may look in its page tables for a virtual-to-physical mapping for an address and transmit translation back to GPU(s) 408, in at least one embodiment. In at least one embodiment, unified memory technology may allow a single unified virtual address space for memory of both CPU(s) 406 and GPU(s) 408, thereby simplifying GPU(s) 408 programming and porting of applications to GPU(s) 408.

In at least one embodiment, GPU(s) 408 may include any number of access counters that may keep track of frequency of access of GPU(s) 408 to memory of other processors. In at least one embodiment, access counter(s) may help ensure that memory pages are moved to physical memory of a processor that is accessing pages most frequently, thereby improving efficiency for memory ranges shared between processors.

In at least one embodiment, one or more of SoC(s) 404 may include any number of cache(s) 412, including those described herein. For example, in at least one embodiment, cache(s) 412 could include a level three (“L3”) cache that is available to both CPU(s) 406 and GPU(s) 408 (e.g., that is connected to CPU(s) 406 and GPU(s) 408). In at least one embodiment, cache(s) 412 may include a write-back cache that may keep track of states of lines, such as by using a cache coherence protocol (e.g., MEI, MESI, MSI, etc.). In at least one embodiment, a L3 cache may include 4 MB of memory or more, depending on embodiment, although smaller cache sizes may be used.

In at least one embodiment, one or more of SoC(s) 404 may include one or more accelerator(s) 414 (e.g., hardware accelerators, software accelerators, or a combination thereof). In at least one embodiment, SoC(s) 404 may include a hardware acceleration cluster that may include optimized hardware accelerators and/or large on-chip memory. In at least one embodiment, large on-chip memory (e.g., 4 MB of SRAM), may enable a hardware acceleration cluster to accelerate neural networks and other calculations. In at least one embodiment, a hardware acceleration cluster may be used to complement GPU(s) 408 and to off-load some of tasks of GPU(s) 408 (e.g., to free up more cycles of GPU(s) 408 for performing other tasks). In at least one embodiment, accelerator(s) 414 could be used for targeted workloads (e.g., perception, convolutional neural networks (“CNNs”), recurrent neural networks (“RNNs”), etc.) that are stable enough to be amenable to acceleration. In at least one embodiment, a CNN may include a region-based or regional convolutional neural networks (“RCNNs”) and Fast RCNNs (e.g., as used for object detection) or other type of CNN.

In at least one embodiment, accelerator(s) 414 (e.g., hardware acceleration cluster) may include one or more deep learning accelerator (“DLA”). In at least one embodiment, DLA(s) may include, without limitation, one or more Tensor processing units (“TPUs”) that may be configured to provide an additional ten trillion operations per second for deep learning applications and inferencing. In at least one embodiment, TPUs may be accelerators configured to, and optimized for, performing image processing functions (e.g., for CNNs, RCNNs, etc.). In at least one embodiment, DLA(s) may further be optimized for a specific set of neural network types and floating point operations, as well as inferencing. In at least one embodiment, design of DLA(s) may provide more performance per millimeter than a typical general-purpose GPU, and typically vastly exceeds performance of a CPU. In at least one embodiment, TPU(s) may perform several functions, including a single-instance convolution function, supporting, for example, INT8, INT16, and FP16 data types for both features and weights, as well as post-processor functions. In at least one embodiment, DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

In at least one embodiment, DLA(s) may perform any function of GPU(s) 408, and by using an inference accelerator, for example, a designer may target either DLA(s) or GPU(s) 408 for any function. For example, in at least one embodiment, a designer may focus processing of CNNs and floating point operations on DLA(s) and leave other functions to GPU(s) 408 and/or accelerator(s) 414.

In at least one embodiment, accelerator(s) 414 may include programmable vision accelerator (“PVA”), which may alternatively be referred to herein as a computer vision accelerator. In at least one embodiment, PVA may be designed and configured to accelerate computer vision algorithms for advanced driver assistance system (“ADAS”) 438, autonomous driving, augmented reality (“AR”) applications, and/or virtual reality (“VR”) applications. In at least one embodiment, PVA may provide a balance between performance and flexibility. For example, in at least one embodiment, each PVA may include, for example and without limitation, any number of reduced instruction set computer (“RISC”) cores, direct memory access (“DMA”), and/or any number of vector processors.

In at least one embodiment, RISC cores may interact with image sensors (e.g., image sensors of any cameras described herein), image signal processor(s), etc. In at least one embodiment, each RISC core may include any amount of memory. In at least one embodiment, RISC cores may use any of a number of protocols, depending on embodiment. In at least one embodiment, RISC cores may execute a real-time operating system (“RTOS”). In at least one embodiment, RISC cores may be implemented using one or more integrated circuit devices, application specific integrated circuits (“ASICs”), and/or memory devices. For example, in at least one embodiment, RISC cores could include an instruction cache and/or a tightly coupled RAM.

In at least one embodiment, DMA may enable components of PVA to access system memory independently of CPU(s) 406. In at least one embodiment, DMA may support any number of features used to provide optimization to a PVA including, but not limited to, supporting multi-dimensional addressing and/or circular addressing. In at least one embodiment, DMA may support up to six or more dimensions of addressing, which may include, without limitation, block width, block height, block depth, horizontal block stepping, vertical block stepping, and/or depth stepping.

In at least one embodiment, vector processors may be programmable processors that may be designed to efficiently and flexibly execute programming for computer vision algorithms and provide signal processing capabilities. In at least one embodiment, a PVA may include a PVA core and two vector processing subsystem partitions. In at least one embodiment, a PVA core may include a processor subsystem, DMA engine(s) (e.g., two DMA engines), and/or other peripherals. In at least one embodiment, a vector processing subsystem may operate as a primary processing engine of a PVA, and may include a vector processing unit (“VPU”), an instruction cache, and/or vector memory (e.g., “VMEM”). In at least one embodiment, VPU core may include a digital signal processor such as, for example, a single instruction, multiple data (“SIMD”), very long instruction word (“VLIW”) digital signal processor. In at least one embodiment, a combination of SIMD and VLIW may enhance throughput and speed.

In at least one embodiment, each of vector processors may include an instruction cache and may be coupled to dedicated memory. As a result, in at least one embodiment, each of vector processors may be configured to execute independently of other vector processors. In at least one embodiment, vector processors that are included in a particular PVA may be configured to employ data parallelism. For instance, in at least one embodiment, plurality of vector processors included in a single PVA may execute a common computer vision algorithm, but on different regions of an image. In at least one embodiment, vector processors included in a particular PVA may simultaneously execute different computer vision algorithms, on one image, or even execute different algorithms on sequential images or portions of an image. In at least one embodiment, among other things, any number of PVAs may be included in hardware acceleration cluster and any number of vector processors may be included in each PVA. In at least one embodiment, PVA may include additional error correcting code (“ECC”) memory, to enhance overall system safety.

In at least one embodiment, accelerator(s) 414 may include a computer vision network on-chip and static random-access memory (“SRAM”), for providing a high-bandwidth, low latency SRAM for accelerator(s) 414. In at least one embodiment, on-chip memory may include at least 4 MB SRAM, comprising, for example and without limitation, eight field-configurable memory blocks, that may be accessible by both a PVA and a DLA. In at least one embodiment, each pair of memory blocks may include an advanced peripheral bus (“APB”) interface, configuration circuitry, a controller, and a multiplexer. In at least one embodiment, any type of memory may be used. In at least one embodiment, a PVA and a DLA may access memory via a backbone that provides a PVA and a DLA with high-speed access to memory. In at least one embodiment, a backbone may include a computer vision network on-chip that interconnects a PVA and a DLA to memory (e.g., using APB).

In at least one embodiment, a computer vision network on-chip may include an interface that determines, before transmission of any control signal/address/data, that both a PVA and a DLA provide ready and valid signals. In at least one embodiment, an interface may provide for separate phases and separate channels for transmitting control signals/addresses/data, as well as burst-type communications for continuous data transfer. In at least one embodiment, an interface may comply with International Organization for Standardization (“ISO”) 24262 or

International Electrotechnical Commission (“IEC”) 41508 standards, although other standards and protocols may be used.

In at least one embodiment, one or more of SoC(s) 404 may include a real-time ray-tracing hardware accelerator. In at least one embodiment, real-time ray-tracing hardware accelerator may be used to quickly and efficiently determine positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses.

In at least one embodiment, accelerator(s) 414 can have a wide array of uses for autonomous driving. In at least one embodiment, a PVA may be used for key processing stages in ADAS and autonomous vehicles. In at least one embodiment, a PVA's capabilities are a good match for algorithmic domains needing predictable processing, at low power and low latency. In other words, a PVA performs well on semi-dense or dense regular computation, even on small data sets, which might require predictable run-times with low latency and low power. In at least one embodiment, such as in vehicle 400, PVAs might be designed to run classic computer vision algorithms, as they can be efficient at object detection and operating on integer math.

For example, according to at least one embodiment of technology, a PVA is used to perform computer stereo vision. In at least one embodiment, a semi-global matching-based algorithm may be used in some examples, although this is not intended to be limiting. In at least one embodiment, applications for Level 3-5 autonomous driving use motion estimation/stereo matching on-the-fly (e.g., structure from motion, pedestrian recognition, lane detection, etc.). In at least one embodiment, a PVA may perform computer stereo vision functions on inputs from two monocular cameras.

In at least one embodiment, a PVA may be used to perform dense optical flow. For example, in at least one embodiment, a PVA could process raw RADAR data (e.g., using a 6D Fast Fourier Transform) to provide processed RADAR data. In at least one embodiment, a PVA is used for time of flight depth processing, by processing raw time of flight data to provide processed time of flight data, for example.

In at least one embodiment, a DLA may be used to run any type of network to enhance control and driving safety, including for example and without limitation, a neural network that outputs a measure of confidence for each object detection. In at least one embodiment, confidence may be represented or interpreted as a probability, or as providing a relative “weight” of each detection compared to other detections. In at least one embodiment, a confidence measure enables a system to make further decisions regarding which detections should be considered as true positive detections rather than false positive detections. In at least one embodiment, a system may set a threshold value for confidence and consider only detections exceeding threshold value as true positive detections. In an embodiment in which an automatic emergency braking (“AEB”) system is used, false positive detections would cause vehicle to automatically perform emergency braking, which is obviously undesirable. In at least one embodiment, highly confident detections may be considered as triggers for AEB. In at least one embodiment, a DLA may run a neural network for regressing confidence value. In at least one embodiment, neural network may take as its input at least some subset of parameters, such as bounding box dimensions, ground plane estimate obtained (e.g., from another subsystem), output from IMU sensor(s) 466 that correlates with vehicle 400 orientation, distance, 3D location estimates of object obtained from neural network and/or other sensors (e.g., LIDAR sensor(s) 464 or RADAR sensor(s) 460), among others.

In at least one embodiment, one or more of SoC(s) 404 may include data store(s) 416 (e.g., memory). In at least one embodiment, data store(s) 416 may be on-chip memory of SoC(s) 404, which may store neural networks to be executed on GPU(s) 408 and/or a DLA. In at least one embodiment, data store(s) 416 may be large enough in capacity to store multiple instances of neural networks for redundancy and safety. In at least one embodiment, data store(s) 416 may comprise L2 or L3 cache(s).

In at least one embodiment, one or more of SoC(s) 404 may include any number of processor(s) 410 (e.g., embedded processors). In at least one embodiment, processor(s) 410 may include a boot and power management processor that may be a dedicated processor and subsystem to handle boot power and management functions and related security enforcement. In at least one embodiment, a boot and power management processor may be a part of a boot sequence of SoC(s) 404 and may provide runtime power management services. In at least one embodiment, a boot power and management processor may provide clock and voltage programming, assistance in system low power state transitions, management of SoC(s) 404 thermals and temperature sensors, and/or management of SoC(s) 404 power states. In at least one embodiment, each temperature sensor may be implemented as a ring-oscillator whose output frequency is proportional to temperature, and SoC(s) 404 may use ring-oscillators to detect temperatures of CPU(s) 406, GPU(s) 408, and/or accelerator(s) 414. In at least one embodiment, if temperatures are determined to exceed a threshold, then a boot and power management processor may enter a temperature fault routine and put SoC(s) 404 into a lower power state and/or put vehicle 400 into a chauffeur to safe stop mode (e.g., bring vehicle 400 to a safe stop).

In at least one embodiment, processor(s) 410 may further include a set of embedded processors that may serve as an audio processing engine which may be an audio subsystem that enables full hardware support for multi-channel audio over multiple interfaces, and a broad and flexible range of audio I/O interfaces. In at least one embodiment, an audio processing engine is a dedicated processor core with a digital signal processor with dedicated RAM.

In at least one embodiment, processor(s) 410 may further include an always-on processor engine that may provide necessary hardware features to support low power sensor management and wake use cases. In at least one embodiment, an always-on processor engine may include, without limitation, a processor core, a tightly coupled RAM, supporting peripherals (e.g., timers and interrupt controllers), various I/O controller peripherals, and routing logic.

In at least one embodiment, processor(s) 410 may further include a safety cluster engine that includes, without limitation, a dedicated processor subsystem to handle safety management for automotive applications. In at least one embodiment, a safety cluster engine may include, without limitation, two or more processor cores, a tightly coupled RAM, support peripherals (e.g., timers, an interrupt controller, etc.), and/or routing logic. In a safety mode, two or more cores may operate, in at least one embodiment, in a lockstep mode and function as a single core with comparison logic to detect any differences between their operations. In at least one embodiment, processor(s) 410 may further include a real-time camera engine that may include, without limitation, a dedicated processor subsystem for handling real-time camera management. In at least one embodiment, processor(s) 410 may further include a high-dynamic range signal processor that may include, without limitation, an image signal processor that is a hardware engine that is part of a camera processing pipeline.

In at least one embodiment, processor(s) 410 may include a video image compositor that may be a processing block (e.g., implemented on a microprocessor) that implements video post-processing functions needed by a video playback application to produce a final image for a player window. In at least one embodiment, a video image compositor may perform lens distortion correction on wide-view camera(s) 470, surround camera(s) 474, and/or on in-cabin monitoring camera sensor(s). In at least one embodiment, in-cabin monitoring camera sensor(s) are preferably monitored by a neural network running on another instance of SoC 404, configured to identify in cabin events and respond accordingly. In at least one embodiment, an in-cabin system may perform, without limitation, lip reading to activate cellular service and place a phone call, dictate emails, change a vehicle's destination, activate or change a vehicle's infotainment system and settings, or provide voice-activated web surfing. In at least one embodiment, certain functions are available to a driver when a vehicle is operating in an autonomous mode and are disabled otherwise.

In at least one embodiment, a video image compositor may include enhanced temporal noise reduction for both spatial and temporal noise reduction. For example, in at least one embodiment, where motion occurs in a video, noise reduction weights spatial information appropriately, decreasing weights of information provided by adjacent frames. In at least one embodiment, where an image or portion of an image does not include motion, temporal noise reduction performed by video image compositor may use information from a previous image to reduce noise in a current image.

In at least one embodiment, a video image compositor may also be configured to perform stereo rectification on input stereo lens frames. In at least one embodiment, a video image compositor may further be used for user interface composition when an operating system desktop is in use, and GPU(s) 408 are not required to continuously render new surfaces. In at least one embodiment, when GPU(s) 408 are powered on and active doing 3D rendering, a video image compositor may be used to offload GPU(s) 408 to improve performance and responsiveness.

In at least one embodiment, one or more SoC of SoC(s) 404 may further include a mobile industry processor interface (“MIPI”) camera serial interface for receiving video and input from cameras, a high-speed interface, and/or a video input block that may be used for a camera and related pixel input functions. In at least one embodiment, one or more of SoC(s) 404 may further include an input/output controller(s) that may be controlled by software and may be used for receiving I/O signals that are uncommitted to a specific role.

In at least one embodiment, one or more Soc of SoC(s) 404 may further include a broad range of peripheral interfaces to enable communication with peripherals, audio encoders/decoders (“codecs”), power management, and/or other devices. In at least one embodiment, SoC(s) 404 may be used to process data from cameras (e.g., connected over Gigabit Multimedia Serial Link and Ethernet channels), sensors (e.g., LIDAR sensor(s) 464, RADAR sensor(s) 460, etc. that may be connected over Ethernet channels), data from bus 402 (e.g., speed of vehicle 400, steering wheel position, etc.), data from GNSS sensor(s) 458 (e.g., connected over a Ethernet bus or a CAN bus), etc. In at least one embodiment, one or more SoC of SoC(s) 404 may further include dedicated high-performance mass storage controllers that may include their own DMA engines, and that may be used to free CPU(s) 406 from routine data management tasks.

In at least one embodiment, SoC(s) 404 may be an end-to-end platform with a flexible architecture that spans automation Levels 3-5, thereby providing a comprehensive functional safety architecture that leverages and makes efficient use of computer vision and ADAS techniques for diversity and redundancy, and provides a platform for a flexible, reliable driving software stack, along with deep learning tools. In at least one embodiment, SoC(s) 404 may be faster, more reliable, and even more energy-efficient and space-efficient than conventional systems. For example, in at least one embodiment, accelerator(s) 414, when combined with CPU(s) 406, GPU(s) 408, and data store(s) 416, may provide for a fast, efficient platform for Level 3-5 autonomous vehicles.

In at least one embodiment, computer vision algorithms may be executed on CPUs, which may be configured using a high-level programming language, such as C, to execute a wide variety of processing algorithms across a wide variety of visual data. However, in at least one embodiment, CPUs are oftentimes unable to meet performance requirements of many computer vision applications, such as those related to execution time and power consumption, for example. In at least one embodiment, many CPUs are unable to execute complex object detection algorithms in real-time, which is used in in-vehicle ADAS applications and in practical Level 3-5 autonomous vehicles.

Embodiments described herein allow for multiple neural networks to be performed simultaneously and/or sequentially, and for results to be combined together to enable Level 3-5 autonomous driving functionality. For example, in at least one embodiment, a CNN executing on a DLA or a discrete GPU (e.g., GPU(s) 420) may include text and word recognition, allowing reading and understanding of traffic signs, including signs for which a neural network has not been specifically trained. In at least one embodiment, a DLA may further include a neural network that is able to identify, interpret, and provide semantic understanding of a sign, and to pass that semantic understanding to path planning modules running on a CPU Complex.

In at least one embodiment, multiple neural networks may be run simultaneously, as for Level 3, 4, or 5 driving. For example, in at least one embodiment, a warning sign stating “Caution: flashing lights indicate icy conditions,” along with an electric light, may be independently or collectively interpreted by several neural networks. In at least one embodiment, such warning sign itself may be identified as a traffic sign by a first deployed neural network (e.g., a neural network that has been trained), text “flashing lights indicate icy conditions” may be interpreted by a second deployed neural network, which informs a vehicle's path planning software (preferably executing on a CPU Complex) that when flashing lights are detected, icy conditions exist. In at least one embodiment, a flashing light may be identified by operating a third deployed neural network over multiple frames, informing a vehicle's path-planning software of a presence (or an absence) of flashing lights. In at least one embodiment, all three neural networks may run simultaneously, such as within a DLA and/or on GPU(s) 408.

In at least one embodiment, a CNN for facial recognition and vehicle owner identification may use data from camera sensors to identify presence of an authorized driver and/or owner of vehicle 400. In at least one embodiment, an always-on sensor processing engine may be used to unlock a vehicle when an owner approaches a driver door and turns on lights, and, in a security mode, to disable such vehicle when an owner leaves such vehicle. In this way, SoC(s) 404 provide for security against theft and/or carjacking.

In at least one embodiment, a CNN for emergency vehicle detection and identification may use data from microphones 496 to detect and identify emergency vehicle sirens. In at least one embodiment, SoC(s) 404 use a CNN for classifying environmental and urban sounds, as well as classifying visual data. In at least one embodiment, a CNN running on a DLA is trained to identify a relative closing speed of an emergency vehicle (e.g., by using a Doppler effect). In at least one embodiment, a CNN may also be trained to identify emergency vehicles specific to a local area in which a vehicle is operating, as identified by GNSS sensor(s) 458. In at least one embodiment, when operating in Europe, a CNN will seek to detect European sirens, and when in North America, a CNN will seek to identify only North American sirens. In at least one embodiment, once an emergency vehicle is detected, a control program may be used to execute an emergency vehicle safety routine, slowing a vehicle, pulling over to a side of a road, parking a vehicle, and/or idling a vehicle, with assistance of ultrasonic sensor(s) 462, until emergency vehicles pass.

In at least one embodiment, vehicle 400 may include CPU(s) 418 (e.g., discrete CPU(s), or dCPU(s)), that may be coupled to SoC(s) 404 via a high-speed interconnect (e.g., PCIe). In at least one embodiment, CPU(s) 418 may include an X86 processor, for example. CPU(s) 418 may be used to perform any of a variety of functions, including arbitrating potentially inconsistent results between ADAS sensors and SoC(s) 404, and/or monitoring status and health of controller(s) 436 and/or an infotainment system on a chip (“infotainment SoC”) 430, for example.

In at least one embodiment, vehicle 400 may include GPU(s) 420 (e.g., discrete GPU(s), or dGPU(s)), that may be coupled to SoC(s) 404 via a high-speed interconnect (e.g., NVIDIA's NVLINK channel). In at least one embodiment, GPU(s) 420 may provide additional artificial intelligence functionality, such as by executing redundant and/or different neural networks and may be used to train and/or update neural networks based at least in part on input (e.g., sensor data) from sensors of a vehicle 400.

In at least one embodiment, vehicle 400 may further include network interface 424 which may include, without limitation, wireless antenna(s) 426 (e.g., one or more wireless antennas for different communication protocols, such as a cellular antenna, a Bluetooth antenna, etc.). In at least one embodiment, network interface 424 may be used to enable wireless connectivity to Internet cloud services (e.g., with server(s) and/or other network devices), with other vehicles, and/or with computing devices (e.g., client devices of passengers). In at least one embodiment, to communicate with other vehicles, a direct link may be established between vehicle 40 and another vehicle and/or an indirect link may be established (e.g., across networks and over the Internet). In at least one embodiment, direct links may be provided using a vehicle-to-vehicle communication link. In at least one embodiment, a vehicle-to-vehicle communication link may provide vehicle 400 information about vehicles in proximity to vehicle 400 (e.g., vehicles in front of, on a side of, and/or behind vehicle 400). In at least one embodiment, such aforementioned functionality may be part of a cooperative adaptive cruise control functionality of vehicle 400.

In at least one embodiment, network interface 424 may include an SoC that provides modulation and demodulation functionality and enables controller(s) 436 to communicate over wireless networks. In at least one embodiment, network interface 424 may include a radio frequency front-end for up-conversion from baseband to radio frequency, and down conversion from radio frequency to baseband. In at least one embodiment, frequency conversions may be performed in any technically feasible fashion. For example, frequency conversions could be performed through well-known processes, and/or using super-heterodyne processes. In at least one embodiment, radio frequency front end functionality may be provided by a separate chip. In at least one embodiment, network interfaces may include wireless functionality for communicating over LTE, WCDMA, UNITS, GSM, CDMA2000, Bluetooth, Bluetooth LE, Wi-Fi, Z-Wave, ZigBee, LoRaWAN, and/or other wireless protocols.

In at least one embodiment, vehicle 400 may further include data store(s) 428 which may include, without limitation, off-chip (e.g., off SoC(s) 404) storage. In at least one embodiment, data store(s) 428 may include, without limitation, one or more storage elements including RAM, SRAM, dynamic random-access memory (“DRAM”), video random-access memory (“VRAM”), flash memory, hard disks, and/or other components and/or devices that may store at least one bit of data.

In at least one embodiment, vehicle 400 may further include GNSS sensor(s) 458 (e.g., GPS and/or assisted GPS sensors), to assist in mapping, perception, occupancy grid generation, and/or path planning functions. In at least one embodiment, any number of GNSS sensor(s) 458 may be used, including, for example and without limitation, a GPS using a USB connector with an Ethernet-to-Serial (e.g., RS-232) bridge.

In at least one embodiment, vehicle 400 may further include RADAR sensor(s) 460. In at least one embodiment, RADAR sensor(s) 460 may be used by vehicle 400 for long-range vehicle detection, even in darkness and/or severe weather conditions. In at least one embodiment, RADAR functional safety levels may be ASIL B. In at least one embodiment, RADAR sensor(s) 460 may use a CAN bus and/or bus 402 (e.g., to transmit data generated by RADAR sensor(s) 460) for control and to access object tracking data, with access to Ethernet channels to access raw data in some examples. In at least one embodiment, a wide variety of RADAR sensor types may be used. For example, and without limitation, RADAR sensor(s) 460 may be suitable for front, rear, and side RADAR use. In at least one embodiment, one or more sensor of RADAR sensors(s) 460 is a Pulse Doppler RADAR sensor.

In at least one embodiment, RADAR sensor(s) 460 may include different configurations, such as long-range with narrow field of view, short-range with wide field of view, short-range side coverage, etc. In at least one embodiment, long-range RADAR may be used for adaptive cruise control functionality. In at least one embodiment, long-range RADAR systems may provide a broad field of view realized by two or more independent scans, such as within a 250 m (meter) range. In at least one embodiment, RADAR sensor(s) 460 may help in distinguishing between static and moving objects and may be used by ADAS system 438 for emergency brake assist and forward collision warning. In at least one embodiment, sensors 460(s) included in a long-range RADAR system may include, without limitation, monostatic multimodal RADAR with multiple (e.g., six or more) fixed RADAR antennae and a high-speed CAN and FlexRay interface. In at least one embodiment, with six antennae, a central four antennae may create a focused beam pattern, designed to record vehicle's 400 surroundings at higher speeds with minimal interference from traffic in adjacent lanes. In at least one embodiment, another two antennae may expand field of view, making it possible to quickly detect vehicles entering or leaving a lane of vehicle 400.

In at least one embodiment, mid-range RADAR systems may include, as an example, a range of up to 160 m (front) or 80 m (rear), and a field of view of up to 42 degrees (front) or 150 degrees (rear). In at least one embodiment, short-range RADAR systems may include, without limitation, any number of RADAR sensor(s) 460 designed to be installed at both ends of a rear bumper. When installed at both ends of a rear bumper, in at least one embodiment, a RADAR sensor system may create two beams that constantly monitor blind spots in a rear direction and next to a vehicle. In at least one embodiment, short-range RADAR systems may be used in ADAS system 438 for blind spot detection and/or lane change assist.

In at least one embodiment, vehicle 400 may further include ultrasonic sensor(s) 462. In at least one embodiment, ultrasonic sensor(s) 462, which may be positioned at a front, a back, and/or side location of vehicle 400, may be used for parking assist and/or to create and update an occupancy grid. In at least one embodiment, a wide variety of ultrasonic sensor(s) 462 may be used, and different ultrasonic sensor(s) 462 may be used for different ranges of detection (e.g., 2.5 m, 4 m). In at least one embodiment, ultrasonic sensor(s) 462 may operate at functional safety levels of ASIL B.

In at least one embodiment, vehicle 400 may include LIDAR sensor(s) 464. In at least one embodiment, LIDAR sensor(s) 464 may be used for object and pedestrian detection, emergency braking, collision avoidance, and/or other functions. In at least one embodiment, LIDAR sensor(s) 464 may operate at functional safety level ASIL B. In at least one embodiment, vehicle 400 may include multiple LIDAR sensors 464 (e.g., two, four, six, etc.) that may use an Ethernet channel (e.g., to provide data to a Gigabit Ethernet switch).

In at least one embodiment, LIDAR sensor(s) 464 may be capable of providing a list of objects and their distances for a 360-degree field of view. In at least one embodiment, commercially available LIDAR sensor(s) 464 may have an advertised range of approximately 100 m, with an accuracy of 2 cm to 3 cm, and with support for a 100 Mbps Ethernet connection, for example. In at least one embodiment, one or more non-protruding LIDAR sensors may be used. In such an embodiment, LIDAR sensor(s) 464 may include a small device that may be embedded into a front, a rear, a side, and/or a corner location of vehicle 400. In at least one embodiment, LIDAR sensor(s) 464, in such an embodiment, may provide up to a 120-degree horizontal and 35-degree vertical field-of-view, with a 200 m range even for low-reflectivity objects. In at least one embodiment, front-mounted LIDAR sensor(s) 464 may be configured for a horizontal field of view between 45 degrees and 135 degrees.

In at least one embodiment, LIDAR technologies, such as 3D flash LIDAR, may also be used. In at least one embodiment, 3D flash LIDAR uses a flash of a laser as a transmission source, to illuminate surroundings of vehicle 400 up to approximately 200 m. In at least one embodiment, a flash LIDAR unit includes, without limitation, a receptor, which records laser pulse transit time and reflected light on each pixel, which in turn corresponds to a range from vehicle 400 to objects. In at least one embodiment, flash LIDAR may allow for highly accurate and distortion-free images of surroundings to be generated with every laser flash. In at least one embodiment, four flash LIDAR sensors may be deployed, one at each side of vehicle 400. In at least one embodiment, 3D flash LIDAR systems include, without limitation, a solid-state 3D staring array LIDAR camera with no moving parts other than a fan (e.g., a non-scanning LIDAR device). In at least one embodiment, flash LIDAR device may use a 5 nanosecond class I (eye-safe) laser pulse per frame and may capture reflected laser light as a 3D range point cloud and co-registered intensity data.

In at least one embodiment, vehicle 400 may further include IMU sensor(s) 466. In at least one embodiment, IMU sensor(s) 466 may be located at a center of a rear axle of vehicle 400. In at least one embodiment, IMU sensor(s) 466 may include, for example and without limitation, accelerometer(s), magnetometer(s), gyroscope(s), a magnetic compass, magnetic compasses, and/or other sensor types. In at least one embodiment, such as in six-axis applications, IMU sensor(s) 466 may include, without limitation, accelerometers and gyroscopes. In at least one embodiment, such as in nine-axis applications, IMU sensor(s) 466 may include, without limitation, accelerometers, gyroscopes, and magnetometers.

In at least one embodiment, IMU sensor(s) 466 may be implemented as a miniature, high performance GPS-Aided Inertial Navigation System (“GPS/INS”) that combines micro-electro-mechanical systems (“MEMS”) inertial sensors, a high-sensitivity GPS receiver, and advanced Kalman filtering algorithms to provide estimates of position, velocity, and attitude. In at least one embodiment, IMU sensor(s) 466 may enable vehicle 400 to estimate its heading without requiring input from a magnetic sensor by directly observing and correlating changes in velocity from a GPS to IMU sensor(s) 466. In at least one embodiment, IMU sensor(s) 466 and GNSS sensor(s) 458 may be combined in a single integrated unit.

In at least one embodiment, vehicle 400 may include microphone(s) 496 placed in and/or around vehicle 400. In at least one embodiment, microphone(s) 496 may be used for emergency vehicle detection and identification, among other things.

In at least one embodiment, vehicle 400 may further include any number of camera types, including stereo camera(s) 468, wide-view camera(s) 470, infrared camera(s) 472, surround camera(s) 474, long-range camera(s) 498, mid-range camera(s) 476, and/or other camera types. In at least one embodiment, cameras may be used to capture image data around an entire periphery of vehicle 400. In at least one embodiment, which types of cameras used depends on vehicle 400. In at least one embodiment, any combination of camera types may be used to provide necessary coverage around vehicle 400. In at least one embodiment, a number of cameras deployed may differ depending on embodiment. For example, in at least one embodiment, vehicle 400 could include six cameras, seven cameras, ten cameras, twelve cameras, or another number of cameras. In at least one embodiment, cameras may support, as an example and without limitation, Gigabit Multimedia Serial Link (“GMSL”) and/or Gigabit Ethernet communications. In at least one embodiment, each camera might be as described with more detail previously herein with respect to FIG. 4A and FIG. 4B.

In at least one embodiment, vehicle 400 may further include vibration sensor(s) 442. In at least one embodiment, vibration sensor(s) 442 may measure vibrations of components of vehicle 400, such as axle(s). For example, in at least one embodiment, changes in vibrations may indicate a change in road surfaces. In at least one embodiment, when two or more vibration sensors 442 are used, differences between vibrations may be used to determine friction or slippage of road surface (e.g., when a difference in vibration is between a power-driven axle and a freely rotating axle).

In at least one embodiment, vehicle 400 may include ADAS system 438. In at least one embodiment, ADAS system 438 may include, without limitation, an SoC, in some examples. In at least one embodiment, ADAS system 438 may include, without limitation, any number and combination of an autonomous/adaptive/automatic cruise control (“ACC”) system, a cooperative adaptive cruise control (“CACC”) system, a forward crash warning (“FCW”) system, an automatic emergency braking (“AEB”) system, a lane departure warning (“LDW)” system, a lane keep assist (“LKA”) system, a blind spot warning (“BSW”) system, a rear cross-traffic warning (“RCTW”) system, a collision warning (“CW”) system, a lane centering (“LC”) system, and/or other systems, features, and/or functionality.

In at least one embodiment, ACC system may use RADAR sensor(s) 460, LIDAR sensor(s) 464, and/or any number of camera(s). In at least one embodiment, ACC system may include a longitudinal ACC system and/or a lateral ACC system. In at least one embodiment, a longitudinal ACC system monitors and controls distance to another vehicle immediately ahead of vehicle 400 and automatically adjusts speed of vehicle 400 to maintain a safe distance from vehicles ahead. In at least one embodiment, a lateral ACC system performs distance keeping, and advises vehicle 400 to change lanes when necessary. In at least one embodiment, a lateral ACC is related to other ADAS applications, such as LC and CW.

In at least one embodiment, a CACC system uses information from other vehicles that may be received via network interface 424 and/or wireless antenna(s) 426 from other vehicles via a wireless link, or indirectly, over a network connection (e.g., over the Internet). In at least one embodiment, direct links may be provided by a vehicle-to-vehicle (“V2V”) communication link, while indirect links may be provided by an infrastructure-to-vehicle (“I2V”) communication link. In general, V2V communication provides information about immediately preceding vehicles (e.g., vehicles immediately ahead of and in same lane as vehicle 400), while I2V communication provides information about traffic further ahead. In at least one embodiment, a CACC system may include either or both I2V and V2V information sources. In at least one embodiment, given information of vehicles ahead of vehicle 400, a CACC system may be more reliable, and it has potential to improve traffic flow smoothness and reduce congestion on road.

In at least one embodiment, an FCW system is designed to alert a driver to a hazard, so that such driver may take corrective action. In at least one embodiment, an FCW system uses a front-facing camera and/or RADAR sensor(s) 460, coupled to a dedicated processor, DSP, FPGA, and/or ASIC, that is electrically coupled to provide driver feedback, such as a display, speaker, and/or vibrating component. In at least one embodiment, an FCW system may provide a warning, such as in form of a sound, visual warning, vibration and/or a quick brake pulse.

In at least one embodiment, an AEB system detects an impending forward collision with another vehicle or other object and may automatically apply brakes if a driver does not take corrective action within a specified time or distance parameter. In at least one embodiment, AEB system may use front-facing camera(s) and/or RADAR sensor(s) 460, coupled to a dedicated processor, DSP, FPGA, and/or ASIC. In at least one embodiment, when an AEB system detects a hazard, it will typically first alert a driver to take corrective action to avoid collision and, if that driver does not take corrective action, that AEB system may automatically apply brakes in an effort to prevent, or at least mitigate, an impact of a predicted collision. In at least one embodiment, an AEB system may include techniques such as dynamic brake support and/or crash imminent braking.

In at least one embodiment, an LDW system provides visual, audible, and/or tactile warnings, such as steering wheel or seat vibrations, to alert driver when vehicle 400 crosses lane markings. In at least one embodiment, an LDW system does not activate when a driver indicates an intentional lane departure, such as by activating a turn signal. In at least one embodiment, an LDW system may use front-side facing cameras, coupled to a dedicated processor, DSP, FPGA, and/or ASIC, that is electrically coupled to provide driver feedback, such as a display, speaker, and/or vibrating component. In at least one embodiment, an LKA system is a variation of an LDW system. In at least one embodiment, an LKA system provides steering input or braking to correct vehicle 400 if vehicle 400 starts to exit its lane.

In at least one embodiment, a BSW system detects and warns a driver of vehicles in an automobile's blind spot. In at least one embodiment, a BSW system may provide a visual, audible, and/or tactile alert to indicate that merging or changing lanes is unsafe. In at least one embodiment, a BSW system may provide an additional warning when a driver uses a turn signal. In at least one embodiment, a BSW system may use rear-side facing camera(s) and/or RADAR sensor(s) 460, coupled to a dedicated processor, DSP, FPGA, and/or ASIC, that is electrically coupled to driver feedback, such as a display, speaker, and/or vibrating component.

In at least one embodiment, an RCTW system may provide visual, audible, and/or tactile notification when an object is detected outside a rear-camera range when vehicle 400 is backing up. In at least one embodiment, an RCTW system includes an AEB system to ensure that vehicle brakes are applied to avoid a crash. In at least one embodiment, an RCTW system may use one or more rear-facing RADAR sensor(s) 460, coupled to a dedicated processor, DSP, FPGA, and/or ASIC, that is electrically coupled to provide driver feedback, such as a display, speaker, and/or vibrating component.

In at least one embodiment, conventional ADAS systems may be prone to false positive results which may be annoying and distracting to a driver, but typically are not catastrophic, because conventional ADAS systems alert a driver and allow that driver to decide whether a safety condition truly exists and act accordingly. In at least one embodiment, vehicle 400 itself decides, in case of conflicting results, whether to heed result from a primary computer or a secondary computer (e.g., a first controller or a second controller of controllers 436). For example, in at least one embodiment, ADAS system 438 may be a backup and/or secondary computer for providing perception information to a backup computer rationality module. In at least one embodiment, a backup computer rationality monitor may run redundant diverse software on hardware components to detect faults in perception and dynamic driving tasks. In at least one embodiment, outputs from ADAS system 438 may be provided to a supervisory MCU. In at least one embodiment, if outputs from a primary computer and outputs from a secondary computer conflict, a supervisory MCU determines how to reconcile conflict to ensure safe operation.

In at least one embodiment, a primary computer may be configured to provide a supervisory MCU with a confidence score, indicating that primary computer's confidence in a chosen result. In at least one embodiment, if that confidence score exceeds a threshold, that supervisory MCU may follow that primary computer's direction, regardless of whether that secondary computer provides a conflicting or inconsistent result. In at least one embodiment, where a confidence score does not meet a threshold, and where primary and secondary computers indicate different results (e.g., a conflict), a supervisory MCU may arbitrate between computers to determine an appropriate outcome.

In at least one embodiment, a supervisory MCU may be configured to run a neural network(s) that is trained and configured to determine, based at least in part on outputs from a primary computer and outputs from a secondary computer, conditions under which that secondary computer provides false alarms. In at least one embodiment, neural network(s) in a supervisory MCU may learn when a secondary computer's output may be trusted, and when it cannot. For example, in at least one embodiment, when that secondary computer is a RADAR-based FCW system, a neural network(s) in that supervisory MCU may learn when an FCW system is identifying metallic objects that are not, in fact, hazards, such as a drainage grate or manhole cover that triggers an alarm. In at least one embodiment, when a secondary computer is a camera-based LDW system, a neural network in a supervisory MCU may learn to override LDW when bicyclists or pedestrians are present and a lane departure is, in fact, a safest maneuver. In at least one embodiment, a supervisory MCU may include at least one of a DLA or a GPU suitable for running neural network(s) with associated memory. In at least one embodiment, a supervisory MCU may comprise and/or be included as a component of SoC(s) 404.

In at least one embodiment, ADAS system 438 may include a secondary computer that performs ADAS functionality using traditional rules of computer vision. In at least one embodiment, that secondary computer may use classic computer vision rules (if-then), and presence of a neural network(s) in a supervisory MCU may improve reliability, safety and performance. For example, in at least one embodiment, diverse implementation and intentional non-identity makes an overall system more fault-tolerant, especially to faults caused by software (or software-hardware interface) functionality. For example, in at least one embodiment, if there is a software bug or error in software running on a primary computer, and non-identical software code running on a secondary computer provides a consistent overall result, then a supervisory MCU may have greater confidence that an overall result is correct, and a bug in software or hardware on that primary computer is not causing a material error.

In at least one embodiment, an output of ADAS system 438 may be fed into a primary computer's perception block and/or a primary computer's dynamic driving task block. For example, in at least one embodiment, if ADAS system 438 indicates a forward crash warning due to an object immediately ahead, a perception block may use this information when identifying objects. In at least one embodiment, a secondary computer may have its own neural network that is trained and thus reduces a risk of false positives, as described herein.

In at least one embodiment, vehicle 400 may further include infotainment SoC 430 (e.g., an in-vehicle infotainment system (IVI)). Although illustrated and described as an SoC, infotainment system SoC 430, in at least one embodiment, may not be an SoC, and may include, without limitation, two or more discrete components. In at least one embodiment, infotainment SoC 430 may include, without limitation, a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, WiFi, etc.), and/or information services (e.g., navigation systems, rear-parking assistance, a radio data system, vehicle related information such as fuel level, total distance covered, brake fuel level, oil level, door open/close, air filter information, etc.) to vehicle 400. For example, infotainment SoC 430 could include radios, disk players, navigation systems, video players, USB and Bluetooth connectivity, carputers, in-car entertainment, WiFi, steering wheel audio controls, hands free voice control, a heads-up display (“HUD”), HMI display 434, a telematics device, a control panel (e.g., for controlling and/or interacting with various components, features, and/or systems), and/or other components. In at least one embodiment, infotainment SoC 430 may further be used to provide information (e.g., visual and/or audible) to user(s) of vehicle 400, such as information from ADAS system 438, autonomous driving information such as planned vehicle maneuvers, trajectories, surrounding environment information (e.g., intersection information, vehicle information, road information, etc.), and/or other information.

In at least one embodiment, infotainment SoC 430 may include any amount and type of GPU functionality. In at least one embodiment, infotainment SoC 430 may communicate over bus 402 with other devices, systems, and/or components of vehicle 400. In at least one embodiment, infotainment SoC 430 may be coupled to a supervisory MCU such that a GPU of an infotainment system may perform some self-driving functions in event that primary controller(s) 436 (e.g., primary and/or backup computers of vehicle 400) fail. In at least one embodiment, infotainment SoC 430 may put vehicle 400 into a chauffeur to safe stop mode, as described herein.

In at least one embodiment, vehicle 400 may further include instrument cluster 432 (e.g., a digital dash, an electronic instrument cluster, a digital instrument panel, etc.). In at least one embodiment, instrument cluster 432 may include, without limitation, a controller and/or supercomputer (e.g., a discrete controller or supercomputer). In at least one embodiment, instrument cluster 432 may include, without limitation, any number and combination of a set of instrumentation such as a speedometer, fuel level, oil pressure, tachometer, odometer, turn indicators, gearshift position indicator, seat belt warning light(s), parking-brake warning light(s), engine-malfunction light(s), supplemental restraint system (e.g., airbag) information, lighting controls, safety system controls, navigation information, etc. In some examples, information may be displayed and/or shared among infotainment SoC 430 and instrument cluster 432. In at least one embodiment, instrument cluster 432 may be included as part of infotainment SoC 430, or vice versa.

Processing logic 150 may be used to perform image processing operations, including color correction operations, associated with one or more embodiments. Details regarding processing logic 150 are provided herein in conjunction with FIG. 1. In at least one embodiment, processing logic 150 may be used in the autonomous vehicle 400 of FIG. 4C for performing image processing operations, including color correction operations.

FIG. 4D is a diagram of a system 476 for communication between cloud-based server(s) and autonomous vehicle 400 of FIG. 4A, according to at least one embodiment. In at least one embodiment, system 476 may include, without limitation, server(s) 478, network(s) 490, and any number and type of vehicles, including vehicle 400. In at least one embodiment, server(s) 478 may include, without limitation, a plurality of GPUs 484(A)-484(H) (collectively referred to herein as GPUs 484), PCIe switches 482(A)-482(D) (collectively referred to herein as PCIe switches 482), and/or CPUs 480(A)-480(B) (collectively referred to herein as CPUs 480). In at least one embodiment, GPUs 484, CPUs 480, and PCIe switches 482 may be interconnected with high-speed interconnects such as, for example and without limitation, NVLink interfaces 488 developed by NVIDIA and/or PCIe connections 486. In at least one embodiment, GPUs 484 are connected via an NVLink and/or NVSwitch SoC and GPUs 484 and PCIe switches 482 are connected via PCIe interconnects. Although eight GPUs 484, two CPUs 480, and four PCIe switches 482 are illustrated, this is not intended to be limiting. In at least one embodiment, each of server(s) 478 may include, without limitation, any number of GPUs 484, CPUs 480, and/or PCIe switches 482, in any combination. For example, in at least one embodiment, server(s) 478 could each include eight, sixteen, thirty-two, and/or more GPUs 484.

In at least one embodiment, server(s) 478 may receive, over network(s) 490 and from vehicles, image data representative of images showing unexpected or changed road conditions, such as recently commenced road-work. In at least one embodiment, server(s) 478 may transmit, over network(s) 490 and to vehicles, neural networks 492, updated or otherwise, and/or map information 494, including, without limitation, information regarding traffic and road conditions.

In at least one embodiment, updates to map information 494 may include, without limitation, updates for HD map 422, such as information regarding construction sites, potholes, detours, flooding, and/or other obstructions. In at least one embodiment, neural networks 492, and/or map information 494 may have resulted from new training and/or experiences represented in data received from any number of vehicles in an environment, and/or based at least in part on training performed at a data center (e.g., using server(s) 478 and/or other servers).

In at least one embodiment, server(s) 478 may be used to train machine learning models (e.g., neural networks) based at least in part on training data. In at least one embodiment, training data may be generated by vehicles, and/or may be generated in a simulation (e.g., using a game engine). In at least one embodiment, any amount of training data is tagged (e.g., where associated neural network benefits from supervised learning) and/or undergoes other pre-processing. In at least one embodiment, any amount of training data is not tagged and/or pre-processed (e.g., where associated neural network does not require supervised learning). In at least one embodiment, once machine learning models are trained, machine learning models may be used by vehicles (e.g., transmitted to vehicles over network(s) 490), and/or machine learning models may be used by server(s) 478 to remotely monitor vehicles.

In at least one embodiment, server(s) 478 may receive data from vehicles and apply data to up-to-date real-time neural networks for real-time intelligent inferencing. In at least one embodiment, server(s) 478 may include deep-learning supercomputers and/or dedicated AI computers powered by GPU(s) 484, such as a DGX and DGX Station machines developed by NVIDIA. However, in at least one embodiment, server(s) 478 may include deep learning infrastructure that uses CPU-powered data centers.

In at least one embodiment, deep-learning infrastructure of server(s) 478 may be capable of fast, real-time inferencing, and may use that capability to evaluate and verify health of processors, software, and/or associated hardware in vehicle 400. For example, in at least one embodiment, deep-learning infrastructure may receive periodic updates from vehicle 400, such as a sequence of images and/or objects that vehicle 400 has located in that sequence of images (e.g., via computer vision and/or other machine learning object classification techniques). In at least one embodiment, deep-learning infrastructure may run its own neural network to identify objects and compare them with objects identified by vehicle 400 and, if results do not match and deep-learning infrastructure concludes that AI in vehicle 400 is malfunctioning, then server(s) 478 may transmit a signal to vehicle 400 instructing a fail-safe computer of vehicle 400 to assume control, notify passengers, and complete a safe parking maneuver.

In at least one embodiment, server(s) 478 may include GPU(s) 484 and one or more programmable inference accelerators (e.g., NVIDIA's TensorRT 3 devices). In at least one embodiment, a combination of GPU-powered servers and inference acceleration may make real-time responsiveness possible. In at least one embodiment, such as where performance is less critical, servers powered by CPUs, FPGAs, and other processors may be used for inferencing. In at least one embodiment, hardware structure(s) implementing processing logic 150 are used to perform one or more embodiments. Details regarding processing logic 150 are provided herein in conjunction with FIG. 1.

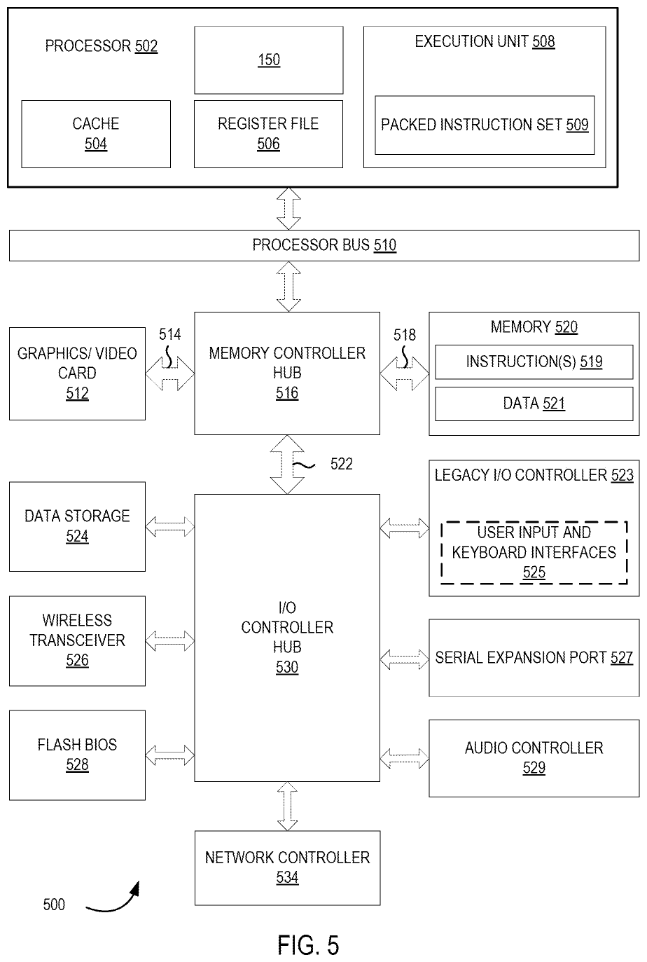

FIG. 5 is a block diagram illustrating an example computer system, which may be a system with interconnected devices and components, a system-on-a-chip (SOC) or some combination thereof formed with a processor that may include execution units to execute an instruction, according to at least one embodiment. In at least one embodiment, a computer system 500 may include, without limitation, a component, such as a processor 502 to employ execution units including logic to perform algorithms for process data, in accordance with present disclosure, such as in embodiment described herein. In at least one embodiment, computer system 500 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 500 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 500 may include, without limitation, processor 502 that may include, without limitation, one or more execution units 508 to perform image processing and white balancing according to techniques described herein. In at least one embodiment, computer system 500 is a single processor desktop or server system, but in another embodiment, computer system 500 may be a multiprocessor system. In at least one embodiment, processor 502 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 502 may be coupled to a processor bus 510 that may transmit data signals between processor 502 and other components in computer system 500.

In at least one embodiment, processor 502 may include, without limitation, a Level 1 (“L1”) internal cache memory (“cache”) 504. In at least one embodiment, processor 502 may have a single internal cache or multiple levels of internal cache. In at least one embodiment, cache memory may reside external to processor 502. Other embodiments may also include a combination of both internal and external caches depending on particular implementation and needs. In at least one embodiment, a register file 506 may store different types of data in various registers including, without limitation, integer registers, floating point registers, status registers, and an instruction pointer register.

In at least one embodiment, execution unit 508, including, without limitation, logic to perform integer and floating point operations, also resides in processor 502. In at least one embodiment, processor 502 may also include a microcode (“ucode”) read only memory (“ROM”) that stores microcode for certain macro instructions. In at least one embodiment, execution unit 508 may include logic to handle a packed instruction set 509. In at least one embodiment, by including packed instruction set 509 in an instruction set of a general-purpose processor, along with associated circuitry to execute instructions, operations used by many multimedia applications may be performed using packed data in processor 502. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 508 may also be used in microcontrollers, embedded processors, graphics devices, DSPs, and other types of logic circuits. In at least one embodiment, computer system 500 may include, without limitation, a memory 520. In at least one embodiment, memory 520 may be a Dynamic Random Access Memory (“DRAM”) device, a Static Random Access Memory (“SRAM”) device, a flash memory device, or another memory device. In at least one embodiment, memory 520 may store instruction(s) 519 and/or data 521 represented by data signals that may be executed by processor 502.

In at least one embodiment, a system logic chip may be coupled to processor bus 510 and memory 520. In at least one embodiment, a system logic chip may include, without limitation, a memory controller hub (“MCH”) 516, and processor 502 may communicate with MCH 516 via processor bus 510. In at least one embodiment, MCH 516 may provide a high bandwidth memory path 518 to memory 520 for instruction and data storage and for storage of graphics commands, data and textures. In at least one embodiment, MCH 516 may direct data signals between processor 502, memory 520, and other components in computer system 500 and to bridge data signals between processor bus 510, memory 520, and a system I/O interface 522. In at least one embodiment, a system logic chip may provide a graphics port for coupling to a graphics controller.

In at least one embodiment, MCH 516 may be coupled to memory 520 through high bandwidth memory path 518 and a graphics/video card 512 may be coupled to MCH 516 through an Accelerated Graphics Port (“AGP”) interconnect 514.

In at least one embodiment, computer system 500 may use system I/O interface 522 as a proprietary hub interface bus to couple MCH 516 to an I/O controller hub (“ICH”) 530. In at least one embodiment, ICH 530 may provide direct connections to some I/O devices via a local I/O bus. In at least one embodiment, a local I/O bus may include, without limitation, a high-speed I/O bus for connecting peripherals to memory 520, a chipset, and processor 502. Examples may include, without limitation, an audio controller 529, a firmware hub (“flash BIOS”) 528, a wireless transceiver 526, a data storage 524, a legacy I/O controller 523 containing user input and keyboard interfaces 525, a serial expansion port 527, such as a Universal Serial Bus (“USB”) port, and a network controller 534. In at least one embodiment, data storage 524 may comprise a hard disk drive, a floppy disk drive, a CD-ROM device, a flash memory device, or other mass storage device.

In at least one embodiment, FIG. 5 illustrates a system, which includes interconnected hardware devices or “chips”, whereas in other embodiments, FIG. 5 may illustrate an example SoC. In at least one embodiment, devices illustrated in FIG. 5 may be interconnected with proprietary interconnects, standardized interconnects (e.g., PCIe) or some combination thereof. In at least one embodiment, one or more components of computer system 500 are interconnected using compute express link (CXL) interconnects.

Processing logic 150 may be used to perform image processing operations, including color correction operations, associated with one or more embodiments. Details regarding processing logic 150 are provided herein in conjunction with FIG. 1. In at least one embodiment, processing logic 150 may be used in the system of FIG. 5 for performing image processing operations, including color correction operations.

FIG. 6 is a block diagram illustrating an electronic device 600 for utilizing a processor 610, according to at least one embodiment. In at least one embodiment, electronic device 600 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 600 may include, without limitation, processor 610 communicatively coupled to any suitable number or kind of components, peripherals, modules, or devices. In at least one embodiment, processor 610 is coupled using a bus or interface, such as a I²C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 6 illustrates a system, which includes interconnected hardware devices or “chips”, whereas in other embodiments, FIG. 6 may illustrate an example SoC. In at least one embodiment, devices illustrated in FIG. 6 may be interconnected with proprietary interconnects, standardized interconnects (e.g., PCIe) or some combination thereof. In at least one embodiment, one or more components of FIG. 6 are interconnected using compute express link (CXL) interconnects.

In at least one embodiment, FIG. 6 may include a display 624, a touch screen 625, a touch pad 630, a Near Field Communications unit (“NFC”) 645, a sensor hub 640, a thermal sensor 646, an Express Chipset (“EC”) 635, a Trusted Platform Module (“TPM”) 638, BIOS/firmware/flash memory (“BIOS, FW Flash”) 622, a DSP 660, a drive 620 such as a Solid State Disk (“SSD”) or a Hard Disk Drive (“HDD”), a wireless local area network unit (“WLAN”) 650, a Bluetooth unit 652, a Wireless Wide Area Network unit (“WWAN”) 656, a Global Positioning System (GPS) unit 655, a camera (“USB 3.0 camera”) 654 such as a USB 3.0 camera, and/or a Low Power Double Data Rate (“LPDDR”) memory unit (“LPDDR3”) 615 implemented in, for example, an LPDDR3 standard. These components may each be implemented in any suitable manner.

In at least one embodiment, other components may be communicatively coupled to processor 610 through components described herein. In at least one embodiment, an accelerometer 641, an ambient light sensor (“ALS”) 642, a compass 643, and a gyroscope 644 may be communicatively coupled to sensor hub 640. In at least one embodiment, a thermal sensor 639, a fan 637, a keyboard 636, and touch pad 630 may be communicatively coupled to EC 635. In at least one embodiment, speakers 663, headphones 664, and a microphone (“mic”) 665 may be communicatively coupled to an audio unit (“audio codec and class D amp”) 662, which may in turn be communicatively coupled to DSP 660. In at least one embodiment, audio unit 662 may include, for example and without limitation, an audio coder/decoder (“codec”) and a class D amplifier. In at least one embodiment, a SIM card (“SIM”) 657 may be communicatively coupled to WWAN unit 656. In at least one embodiment, components such as WLAN unit 650 and Bluetooth unit 652, as well as WWAN unit 656 may be implemented in a Next Generation Form Factor (“NGFF”).

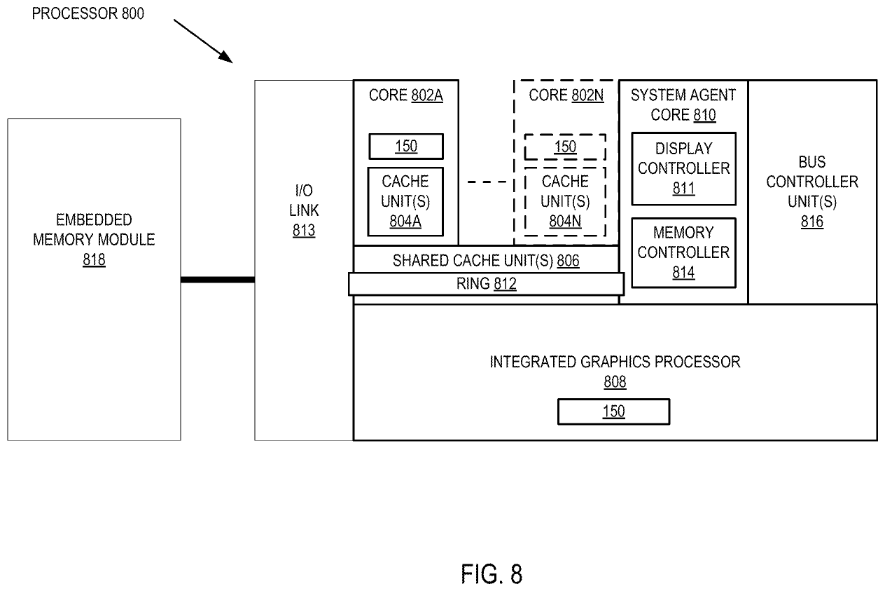

Processing logic 150 may be used to perform image processing operations, including color correction operations, associated with one or more embodiments. Details regarding processing logic 150 are provided herein in conjunction with FIG. 1. In at least one embodiment, processing logic 150 may be used in the electronic device of FIG. 8 for performing image processing operations, including color correction operations.

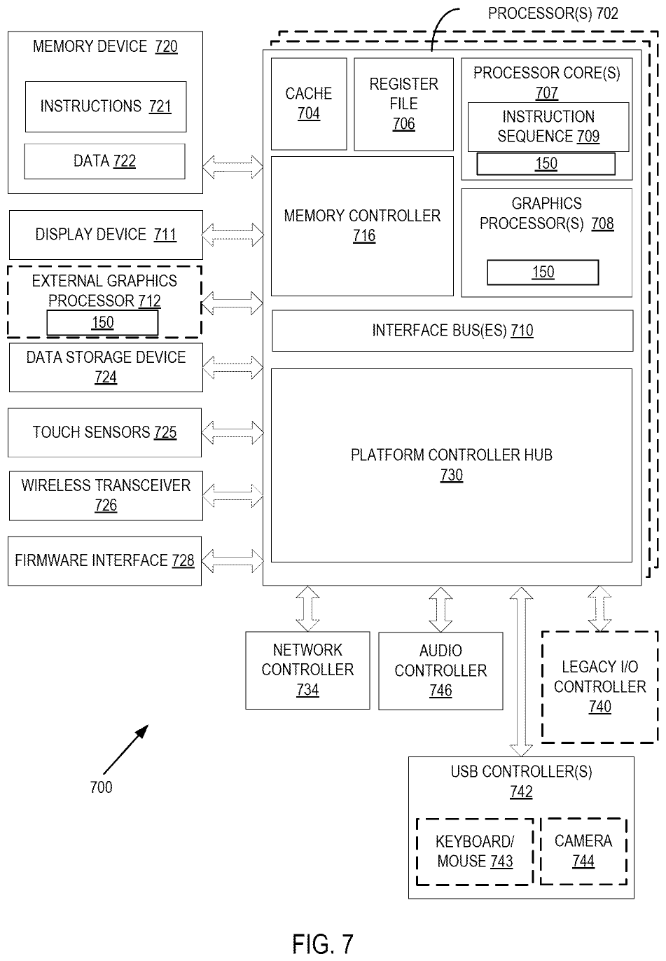

FIG. 7 is a block diagram of a processing system, according to at least one embodiment. In at least one embodiment, system 700 includes one or more processors 702 and one or more graphics processors 708, and may be a single processor desktop system, a multiprocessor workstation system, or a server system having a large number of processors 702 or processor cores 707. In at least one embodiment, system 700 is a processing platform incorporated within a system-on-a-chip (SoC) integrated circuit for use in mobile, handheld, or embedded devices.

In at least one embodiment, system 700 can include, or be incorporated within a server-based gaming platform, a game console, including a game and media console, a mobile gaming console, a handheld game console, or an online game console. In at least one embodiment, system 700 is a mobile phone, a smart phone, a tablet computing device or a mobile Internet device. In at least one embodiment, processing system 700 can also include, couple with, or be integrated within a wearable device, such as a smart watch wearable device, a smart eyewear device, an augmented reality device, or a virtual reality device. In at least one embodiment, processing system 700 is a television or set top box device having one or more processors 702 and a graphical interface generated by one or more graphics processors 708.

In at least one embodiment, one or more processors 702 each include one or more processor cores 707 to process instructions which, when executed, perform operations for system and user software. In at least one embodiment, each of one or more processor cores 707 is configured to process a specific instruction sequence 709. In at least one embodiment, instruction sequence 709 may facilitate Complex Instruction Set Computing (CISC), Reduced Instruction Set Computing (RISC), or computing via a Very Long Instruction Word (VLIW). In at least one embodiment, processor cores 707 may each process a different instruction sequence 709, which may include instructions to facilitate emulation of other instruction sequences. In at least one embodiment, processor core 707 may also include other processing devices, such a Digital Signal Processor (DSP).

In at least one embodiment, processor 702 includes a cache memory 704. In at least one embodiment, processor 702 can have a single internal cache or multiple levels of internal cache. In at least one embodiment, cache memory is shared among various components of processor 702. In at least one embodiment, processor 702 also uses an external cache (e.g., a Level-3 (L3) cache or Last Level Cache (LLC)) (not shown), which may be shared among processor cores 707 using known cache coherency techniques. In at least one embodiment, a register file 706 is additionally included in processor 702, which may include different types of registers for storing different types of data (e.g., integer registers, floating point registers, status registers, and an instruction pointer register). In at least one embodiment, register file 706 may include general-purpose registers or other registers.

In at least one embodiment, one or more processor(s) 702 are coupled with one or more interface bus(es) 710 to transmit communication signals such as address, data, or control signals between processor 702 and other components in system 700. In at least one embodiment, interface bus 710 can be a processor bus, such as a version of a Direct Media Interface (DMI) bus. In at least one embodiment, interface bus 710 is not limited to a DMI bus, and may include one or more Peripheral Component Interconnect buses (e.g., PCI, PCI Express), memory busses, or other types of interface busses. In at least one embodiment processor(s) 702 include an integrated memory controller 716 and a platform controller hub 730. In at least one embodiment, memory controller 716 facilitates communication between a memory device and other components of system 700, while platform controller hub (PCH) 730 provides connections to I/O devices via a local I/O bus.

In at least one embodiment, a memory device 720 can be a dynamic random access memory (DRAM) device, a static random access memory (SRAM) device, flash memory device, phase-change memory device, or some other memory device having suitable performance to serve as process memory. In at least one embodiment, memory device 720 can operate as system memory for system 700, to store data 722 and instructions 721 for use when one or more processors 702 executes an application or process. In at least one embodiment, memory controller 716 also couples with an optional external graphics processor 712, which may communicate with one or more graphics processors 708 in processors 702 to perform graphics and media operations. In at least one embodiment, a display device 711 can connect to processor(s) 702. In at least one embodiment, display device 711 can include one or more of an internal display device, as in a mobile electronic device or a laptop device, or an external display device attached via a display interface (e.g., DisplayPort, etc.). In at least one embodiment, display device 711 can include a head mounted display (HMD) such as a stereoscopic display device for use in virtual reality (VR) applications or augmented reality (AR) applications.

In at least one embodiment, platform controller hub 730 enables peripherals to connect to memory device 720 and processor 702 via a high-speed I/O bus. In at least one embodiment, I/O peripherals include, but are not limited to, an audio controller 746, a network controller 734, a firmware interface 728, a wireless transceiver 726, touch sensors 725, a data storage device 724 (e.g., hard disk drive, flash memory, etc.). In at least one embodiment, data storage device 724 can connect via a storage interface (e.g., SATA) or via a peripheral bus, such as a Peripheral Component Interconnect bus (e.g., PCI, PCI Express). In at least one embodiment, touch sensors 725 can include touch screen sensors, pressure sensors, or fingerprint sensors. In at least one embodiment, wireless transceiver 726 can be a Wi-Fi transceiver, a Bluetooth transceiver, or a mobile network transceiver such as a 3G, 4G, or Long Term Evolution (LTE) transceiver. In at least one embodiment, firmware interface 728 enables communication with system firmware, and can be, for example, a unified extensible firmware interface (UEFI). In at least one embodiment, network controller 734 can enable a network connection to a wired network. In at least one embodiment, a high-performance network controller (not shown) couples with interface bus 710. In at least one embodiment, audio controller 746 is a multi-channel high definition audio controller. In at least one embodiment, system 700 includes an optional legacy I/O controller 740 for coupling legacy (e.g., Personal System 2 (PS/2)) devices to system 700. In at least one embodiment, platform controller hub 730 can also connect to one or more Universal Serial Bus (USB) controllers 742 connect input devices, such as keyboard and mouse 743 combinations, a camera 744, or other USB input devices.

In at least one embodiment, an instance of memory controller 716 and platform controller hub 730 may be integrated into a discreet external graphics processor, such as external graphics processor 712. In at least one embodiment, platform controller hub 730 and/or memory controller 716 may be external to one or more processor(s) 702. For example, in at least one embodiment, system 700 can include an external memory controller 716 and platform controller hub 730, which may be configured as a memory controller hub and peripheral controller hub within a system chipset that is in communication with processor(s) 702.

Processing logic 150 may be used to perform image processing operations, including color correction operations, associated with one or more embodiments. Details regarding processing logic 150 are provided herein in conjunction with FIG. 1. In at least one embodiment, processing logic 150 may be used in the system of FIG. 7 for performing image processing operations, including color correction operations.

FIG. 8 is a block diagram of a processor 800 having one or more processor cores 802A-802N, an integrated memory controller 814, and an integrated graphics processor 808, according to at least one embodiment. In at least one embodiment, processor 800 can include additional cores up to and including additional core 802N represented by dashed lined boxes. In at least one embodiment, each of processor cores 802A-802N includes one or more internal cache units 804A-804N. In at least one embodiment, each processor core also has access to one or more shared cached units 806.

In at least one embodiment, internal cache units 804A-804N and shared cache units 806 represent a cache memory hierarchy within processor 800. In at least one embodiment, cache memory units 804A-804N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 806 and 804A-804N.

In at least one embodiment, processor 800 may also include a set of one or more bus controller units 816 and a system agent core 810. In at least one embodiment, bus controller units 816 manage a set of peripheral buses, such as one or more PCI or PCI express busses. In at least one embodiment, system agent core 810 provides management functionality for various processor components. In at least one embodiment, system agent core 810 includes one or more integrated memory controllers 814 to manage access to various external memory devices (not shown).

In at least one embodiment, one or more of processor cores 802A-802N include support for simultaneous multi-threading. In at least one embodiment, system agent core 810 includes components for coordinating and operating cores 802A-802N during multi-threaded processing. In at least one embodiment, system agent core 810 may additionally include a power control unit (PCU), which includes logic and components to regulate one or more power states of processor cores 802A-802N and graphics processor 808.

In at least one embodiment, processor 800 additionally includes graphics processor 808 to execute graphics processing operations. In at least one embodiment, graphics processor 808 couples with shared cache units 806, and system agent core 810, including one or more integrated memory controllers 814. In at least one embodiment, system agent core 810 also includes a display controller 811 to drive graphics processor output to one or more coupled displays. In at least one embodiment, display controller 811 may also be a separate module coupled with graphics processor 808 via at least one interconnect, or may be integrated within graphics processor 808.

In at least one embodiment, a ring-based interconnect unit 812 is used to couple internal components of processor 800. In at least one embodiment, an alternative interconnect unit may be used, such as a point-to-point interconnect, a switched interconnect, or other techniques. In at least one embodiment, graphics processor 808 couples with ring interconnect 812 via an I/O link 2113.

In at least one embodiment, I/O link 813 represents at least one of multiple varieties of I/O interconnects, including an on package I/O interconnect which facilitates communication between various processor components and a high-performance embedded memory module 818, such as an eDRAM module. In at least one embodiment, each of processor cores 802A-802N and graphics processor 808 use embedded memory module 818 as a shared Last Level Cache.

In at least one embodiment, processor cores 802A-802N are homogeneous cores executing a common instruction set architecture. In at least one embodiment, processor cores 802A-802N are heterogeneous in terms of instruction set architecture (ISA), where one or more of processor cores 802A-802N execute a common instruction set, while one or more other cores of processor cores 802A-802N executes a subset of a common instruction set or a different instruction set. In at least one embodiment, processor cores 802A-802N are heterogeneous in terms of microarchitecture, where one or more cores having a relatively higher power consumption couple with one or more power cores having a lower power consumption. In at least one embodiment, processor 800 can be implemented on one or more chips or as an SoC integrated circuit.

Processing logic 150 may be used to perform image processing operations, including color correction operations, associated with one or more embodiments. Details regarding processing logic 150 are provided herein in conjunction with FIG. 1. In at least one embodiment, processing logic 150 may be incorporated into graphics processor 808. For example, in at least one embodiment, image processing and/or white balancing techniques described herein may use one or more of ALUs embodied in a 3D pipeline, graphics core(s) 802, shared function logic, or other logic in FIG. 8. Moreover, in at least one embodiment, image processing and/or color correction operations described herein may be done using logic other than logic illustrated in FIG. 1. In at least one embodiment, parameters may be stored in on-chip or off-chip memory and/or registers (shown or not shown) that configure ALUs of processor 800 to perform one or more image processing and/or white balancing techniques described herein.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (e.g., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
initializing a color mapping model that maps colors, within a subspace of an input color space localized around a target color, to an adjusted color space; and
adjusting at least one parameter of the color mapping model to reduce an amount of visible artifacts produced by the color mapping model.

2. The method of claim 1, wherein the color mapping model is parameterized by the target color and an adjusted target color.

3. The method of claim 2, wherein the color mapping model is a cuboid model centered about the target color and further parameterized by a first vertex and a second vertex.

4. The method of claim 2, wherein the color mapping model is an ellipsoid model centered about the target color and further parameterized by a first radius, a second radius, and a third radius.

5. The method of claim 2, further comprising:
identifying an object associated with a memory color within an image in the original color space; and
initializing the color mapping model by setting a color of the object within the image as the target color and a defined color associated with the memory color as the adjusted target color.

6. The method of claim 1, further comprising:
applying the color mapping model to at least one test image to generate at least one adjusted test image;
determining whether one or more visible artifacts is produced in the at least one adjusted test image; and
based on a determination that one or more visible artifact is produced, adjusting at least one parameter of the color mapping model to minimize the amount of visible artifacts produced.

7. The method of claim 6, wherein the at least one test image comprises at least one synthetically generated image comprising a color ramp associated with the color mapping model, and
wherein the determining whether one or more visible artifacts is produced in the at least one adjusted test images comprises:
performing an artifact detection process on the at least one adjusted test image to obtain artifact detection information; and
comparing the artifact detection information to a visibility threshold to determine whether one or more visible artifacts is produced.

8. The method of claim 1, further comprising:
initializing another color mapping model that maps colors, within another subspace of the input color space localized around another target color, to the adjusted color space; and
adjusting at least one parameter of the color mapping model or the another color mapping model to reduce an amount of visible artifacts produced by the color mapping model and the another color mapping model.

9. A system comprising:
one or more processing units to perform operations comprising:
initializing a color mapping model that maps colors, within a subspace of an input color space localized around a target color, to an adjusted color space; and
adjusting at least one parameter of the color mapping model to reduce an amount of visible artifacts produced by the color mapping model.

10. The system of claim 9, wherein the color mapping model is parameterized by the target color and an adjusted target color.

11. The system of claim 10, wherein the color mapping model is a cuboid model centered about the target color and further parameterized by a first vertex and a second vertex.

12. The system of claim 10, wherein the color mapping model is an ellipsoid model centered about the target color and further parameterized by a first radius, a second radius, and a third radius.

13. The system of claim 9, wherein the one or more processing units are further to perform operations comprising:
identifying an object associated with a memory color within an image in the original color space; and
initializing the color mapping model by setting a color of the object within the image as the target color and a defined color associated with the memory color as the adjusted target color.

14. The system of claim 9, wherein the one or more processing units are further to perform operations comprising:
applying the color mapping model to at least one test image to generate at least one adjusted test image;
determining whether one or more visible artifacts is produced in the at least one adjusted test image; and
based on a determination that one or more visible artifact is produced, adjusting at least one parameter of the color mapping model to minimize the amount of visible artifacts produced.

15. The system of claim 14, wherein the at least one test image comprises at least one synthetically generated image comprising a color ramp associated with the color mapping model, and
wherein the determining whether one or more visible artifacts is produced in the at least one adjusted test images comprises:
performing an artifact detection process on the at least one adjusted test image to obtain artifact detection information; and
comparing the artifact detection information to a visibility threshold to determine whether one or more visible artifacts is produced.

16. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for presenting one or more of virtual reality content, augmented reality content, or mixed reality content;
a system for real-time streaming applications;
a system for performing deep learning operations;
a system implemented using an edge device;
a system implemented using a robot;
a system for performing conversational AI operations;
a system implementing one or more language models;
a system implementing one or more large language models (LLMs);
a system for performing one or more generative AI operations;
a system for generating synthetic data;
a system incorporating one or more virtual machines (VMs);
a system implemented at least partially in a data center; or
a system implemented at least partially using cloud computing resources.

17. A method comprising:
identifying a color mapping model that maps colors within a subspace of an input color space localized around a target color to an adjusted color space; and
applying the color mapping model to an input image to adjust a value of one or more pixels of the input image that fall within the subspace.

18. The method of claim 2, wherein the applying the color mapping model to the input image further comprises:
determining, for each of one or more pixels of the input image, whether a pixel value falls within the subspace; and
based on a determination that the pixel value falls within the subspace, computing an adjusted pixel value using the color mapping model.

19. The method of claim 2, wherein the color mapping model is a cuboid model centered about the target color and further parameterized by a first vertex and a second vertex.

20. The method of claim 2, wherein the color mapping model is an ellipsoid model centered about the target color and further parameterized by a first radius, a second radius, and a third radius.
